(19) United States
(12) Patent Application Publication
(10) Pub. No.: US 2016/0224707 A1
(43) Pub. Date: Aug. 4, 2016

(54) APPARATUS AND METHOD FOR MAGNETIC FIELD SIMULATION

(71) Applicant: FUJITSU LIMITED, Kawasaki-shi (JP)

(72) Inventor: Koichi Shimizu, Inagi (JP)

(73) Assignee: FUJITSU LIMITED, Kawasaki-shi (JP)

(21) Appl. No.: 14/987,826

(22) Filed: Jan. 5, 2016

(30) Foreign Application Priority Data
Feb. 2, 2015 (JP) 2015-018105

(51) Int. Cl. G06F 17/50; G06F 17/16

(52) U.S. Cl. CPC G06F 17/5018; G06F 17/16

(57) ABSTRACT

A model includes first and second elements. The first element includes a first plane, and the second element includes a second plane. The second plane includes an overlapping area that overlaps with the first plane and a non-overlapping area that is outside the first plane. A magnetic field simulator apparatus calculates second magnetic field data for the overlapping area of the second plane, based on position data indicating a position of the first plane, as well as on first magnetic field data for the first plane. The magnetic field simulator apparatus further calculates third magnetic field data for the non-overlapping area, based on the second magnetic field data and a relative position of the non-overlapping area with respect to the overlapping area.

### CROSS-REFERENCE TO RELATED APPLICATION

This application is based upon and claims the benefit of priority of the prior Japanese Patent Application No. 2015-018105, filed on Feb. 2, 2015, the entire contents of which are incorporated herein by reference.

### FIELD

The embodiments discussed herein relate to an apparatus and method for magnetic field simulation.

### BACKGROUND

As computers have become more and more powerful, the numerical analysis has been increasingly used to simulate various physical phenomena. The finite element method (FEM) is known as a technique for numerical analysis and used to numerically find approximate solutions for differential equations that are hard to solve with an analytical method. Briefly, the method subdivides a two-dimensional or three-dimensional problem space into small regions called “elements” and calculates an approximate solution for the original equations by applying, for each element, relatively simple interpolation functions (e.g., linear functions) to approximate the original equations. For example, a computer obtains an approximate solution by solving a large-scale system of linear equations with a sparse coefficient matrix.

There are two types of FEM, called “node-based” and “edge-based,” that use different places for variables representing unknowns to be solved. The node-based FEM assigns a variable to each node (vertex) of elements, whereas the edge-based FEM assigns it to each edge of elements. For the purpose of magnetic field analysis, the edge-based FEM is advantageous over the node-based FEM in term of accuracy of numerical analysis, since it preserves magnetic flux and a line integral along a loop is zero. Edge-based numerical techniques are thus used for a magnetic field simulation.

As an example of edge-based FEM, a method for solving partial differential equations is proposed to analyze variations of a physical quantity in the modeling space in which some of multiple objects are moving (e.g., a coil moving relative to an iron core). This method divides an individual object and its surrounding area into a plurality of elements. Different objects (e.g., iron core and coil) are allowed to have different element shapes. In addition, elements of one object are allowed to overlap with elements of other objects in the space. These things facilitate entry of model data.

The above method determines new positions of moving objects in the model, thereby detecting elements that overlap with others. Two overlapping elements, however, do not necessarily share their edges. Accordingly, the method interconnects data of these overlapping elements by using interpolation to insert internal vectors of one element into a boundary edge of the other element. In this “interpolation,” inner products are calculated between each internal vector of one element and a direction vector representing the boundary edge of the other element, thus obtaining a component term along the boundary edge. Since the above process has interconnected overlapping elements, the proposed method now produces a coefficient matrix of simultaneous equations for the entire set of elements and solves these simultaneous equations.

In the related techniques, a simulator apparatus that performs an electromagnetic field analysis with a finite-difference time-domain (FDTD) method is proposed. Also proposed is an analyzer apparatus for solving simultaneously an electromagnetic field problem, temperature field problem, and fluid field problem by using several kinds of methods including edge-based FEM.

See, for example, the following patent documents:

Japanese Laid-open Patent Publication No. 9-44473

Japanese Laid-open Patent Publication No. 2004-4054

Japanese Laid-open Patent Publication No. 2012-74016

One of the applications of edge-based FEM is a magnetic field analysis of an object formed from multiple components whose relative positions vary with time as in a rotating electric motor. It is preferable in this application that the analyzer can use the original set of elements even if their relative positions are changed. However, a change in the component positions could disrupt continuity of some elements on the opposite sides of the boundary between those components. That is, some adjacent elements could loose their shared edges. If independent variables are defined for unknowns at individual edges, and if shared edges of adjacent elements are lost, the flow of magnetic flux among these elements would not be expressed properly in the model.

One possible solution for the above problem about elements on opposite sides of the boundary plane is to describe unknowns at the edges of elements on one side, not as independent variables, but as functions of variables of elements on the other side, as in the foregoing method for solving partial differential equations. However, the foregoing method is able to describe an unknown at an edge of a certain element only under the condition that the edge in question is wholly in contact with one or more planes of other elements. When a variation of element positions has caused one part of some element to lose its contact with any other element, the foregoing method is unable to express a flow of magnetic flux at that part.

### SUMMARY

In one aspect, there is provided a non-transitory computer-readable storage medium storing a program. The program causes a computer to perform a procedure including: calculating, based on position data indicating a position of a first plane in a model and first magnetic field data for the first plane, second magnetic field data for an overlapping area of a second plane in the model, the first and second planes respectively belonging to first and second elements of the model, the overlapping area being a part of the second plane that overlaps with the first plane, the second plane having a non-overlapping area that is outside the first plane; and calculating third magnetic field data for the non-overlapping area of the second plane, based on the second magnetic field data and a relative position of the non-overlapping area with respect to the overlapping area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a magnetic field simulator apparatus according to a first embodiment;

FIG. 2 is a block diagram illustrating an exemplary hardware configuration of a magnetic field simulator apparatus;

FIGS. 3A and 3B illustrate examples of unknowns in an edge-based FEM;

FIG. 4 illustrates an exemplary model of an electric motor;

FIG. 5 illustrates an exemplary model of an electric motor that has rotated;

FIG. 6 illustrates an example of master-side and slave-side elements;

FIG. 7A to 7D illustrate various combinations of master-plane and slave-plane shapes;

FIG. 8 illustrates a first exemplary overlap of a slave plane with master planes;

FIG. 9 illustrates a second exemplary overlap of a slave plane with master planes;

FIG. 10 illustrates a third exemplary overlap of a slave plane with master planes;

FIG. 11 is a block diagram illustrating an example of functions implemented in the proposed magnetic field simulator apparatus;

FIG. 12 illustrates an exemplary structure of geometrical data;

FIG. 13 illustrates an exemplary structure of weight data; and

FIG. 14 is a flowchart illustrating an exemplary procedure for combining variables.

### DESCRIPTION OF EMBODIMENTS

Several embodiments will be described below with reference to the accompanying drawings.

### (a) First Embodiment

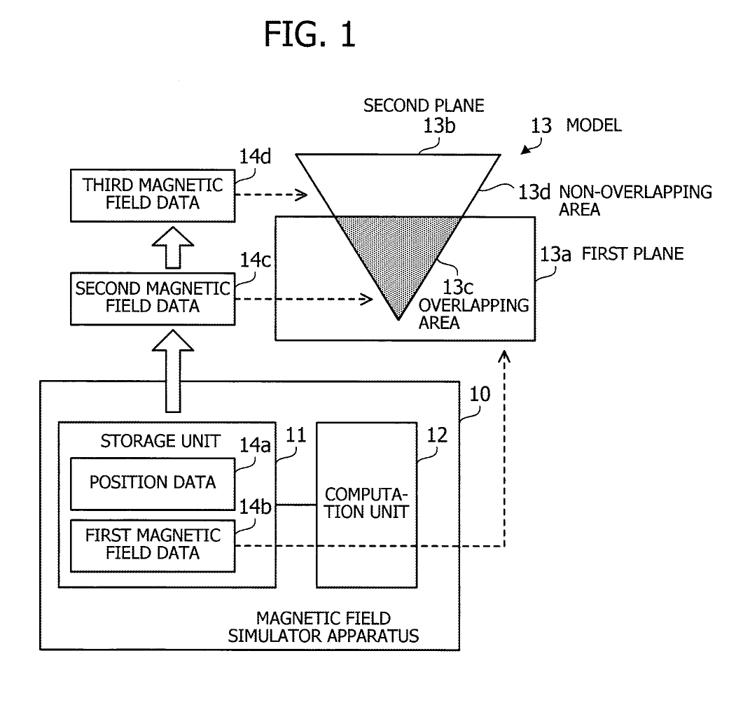

FIG. 1 illustrates a magnetic field simulator apparatus according to a first embodiment. The illustrated magnetic field simulator apparatus 10 analyzes a magnetic field by using a finite element method based on edge elements (edge-based FEM). For example, the magnetic field simulator apparatus 10 simulates a distribution of vector potentials in an object under analysis. The use of an edge-based FEM enables more accurate approximation of physical values that are hard to obtain with an analytical method.

The magnetic field simulator apparatus 10 uses a model 13 representing the object under analysis. Preferably this model 13 is three-dimensional. The magnetic field simulator apparatus 10 divides the model 13 into small segments called “elements.” In the case of a three-dimensional model, each element is a tetrahedron having four triangular surfaces or a hexahedron having six quadrangular surfaces. The edge-based FEM calculates variables that have been defined at the edges of each such element to represent unknowns to be solved. The magnetic field simulator apparatus 10 approximates the original equation by using relatively simple interpolation functions (e.g., linear functions) applicable for individual elements. The magnetic field simulator apparatus 10 calculates unknowns in the model 13, thereby obtaining a field of vector potential or other physical quantity related to the magnetic field. For this calculation, the magnetic field simulator apparatus 10 produces a sparse coefficient matrix representing large-scale linear equations.

The first embodiment assumes that the object under analysis is formed from multiple components whose relative positions may vary. For example, the model 13 may represent an electric motor having a stator and a rotor. The stator is the stationary part of the motor, whereas the rotor turns and thus varies its angular position relative to the stator. The magnetic field simulator apparatus 10 simulates variations of a specific physical quantity (e.g., magnetic field) with time. This means that the simulation has to take into account a motion of the model 13 that happens between different time points. It would be preferable if the same model 13 could be used for simulation at different time points without the need for re-dividing it into elements. However, a change in the relative positions of model components disrupts continuity of some adjacent elements at the boundary of those changed components. That is, some of the formerly adjacent elements could lose their shared edges. The edge-based FEM, on the other hand, basically has to define independent variables at individual edges. If a shared edge of adjacent elements is lost, the magnetic flux flow between these elements would not be expressed properly in the model 13, thus spoiling the accuracy of analysis.

The proposed magnetic field simulator apparatus 10 is therefore designed to associate unknowns between adjacent elements that have lost continuity as a result of a change in their relative positions. Specifically, the model 13 includes a first element having a first plane 13a and a second element having a second plane 13b. The two planes 13a and 13b are located at a boundary of two components whose relative positions have changed. The first plane 13a does not share any edge with the second plane 13b, or in other words, these two planes 13a and 13b are discontinuous. The first and second planes 13a and 13b may have their own two-dimensional shapes, such as triangles and quadrangles. The illustrated second plane 13b includes an overlapping area 13c and a non-overlapping area 13d. That is, the overlapping area 13c overlaps with the first plane 13a, while the non-overlapping area 13d does not overlaps with the first plane 13a or any other plane. Although FIG. 1 does not depict it, the second plane 13b may further include other overlapping areas that overlap with some planes of other elements. In this way, the second plane 13b partially overlaps with one or more planes of other elements. The next part will describe how to associate the unknowns between those planes 13a and 13b.

The magnetic field simulator apparatus 10 includes a storage unit 11 and a computation unit 12. The storage unit 11 may be a volatile memory device such as a random access memory (RAM), or may be a non-volatile storage device such as a hard disk drive (HDD) or flash memory. The computation unit 12 may be a central processing unit (CPU), digital signal processor (DSP), or any other processor. The computation unit 12 may also include an application-specific integrated circuit (ASIC), field-programmable gate array (FPGA), or any other electronic circuit designed for special purposes. Such processors or circuits are configured to execute a magnetic field simulator program loaded on a memory (e.g., RAM). The term “processor” may be used to refer to a single processing device or a multiprocessor system including two or more processing devices.

The storage unit 11 provides a storage space for various data of the model 13. More particularly, the storage unit 11 stores position data 14a and first magnetic field data 14b. The position data 14a includes at least information about the position of the first plane 13a noted above. For example, the position data 14a describes the position of each vertex or edge of the first plane 13a, or of the center of gravity of the first plane 13a. The position data 14a may also include such position information for the position of the second plane 13b. The first magnetic field data 14b includes information about a magnetic field in the first plane 13a. For example, the first magnetic field data 14b includes variables defined at each edge of the first plane 13a. More specifically, the vector potential of such an edge is given as the product of a direction vector along the edge and a coefficient indicating its magnitude. The coefficient is what is to be solved as an unknown, and a variable is thus assigned to the edge to represent the coefficient.

The computation unit 12 calculates second magnetic field data 14c for the overlapping area 13c of the second plane 13b, based on the position data 14a and first magnetic field data 14b stored in the storage unit 11. For example, this second magnetic field data 14c describes the magnetic field on surrounding line segments of the overlapping area 13c, excluding its boundary line with the non-overlapping area 13d. That is, the second magnetic field data 14c includes equations that express unknowns indicating the physical quantity at some line segments on the edges of the second plane 13b. These equations use variables defined at the edges of the first plane 13a, and more specifically, they are linear polynomials representing linear combinations of those variables. The unknowns corresponding to the surrounding line segments of the overlapping area 13c (except for the boundary line between the overlapping area 13c and non-overlapping area 13d) are dependent on the unknowns corresponding to edges of the first plane 13a.

The second magnetic field data 14c also includes, for example, an equation for the boundary line between the overlapping area 13c and non-overlapping area 13d. This equation expresses an unknown physical value on the boundary line in the form of a linear polynomial of variables defined for edges of the first plane 13a, similarly to the unknowns on surrounding line segments of the overlapping area 13c discussed above.

The computation unit 12 then calculates third magnetic field data 14d for the non-overlapping area 13d, based on the second magnetic field data 14c calculated above, as well as on the relative position of the non-overlapping area 13d with respect to the overlapping area 13c. This third magnetic field data 14d includes, for example, equations that expresses unknown physical values in surrounding line segments of the non-overlapping area 13d (i.e., part of the edges of the second plane 13b) excluding the boundary line with the overlapping area 13c. These equations use variables defined at the edges of the first plane 13a, and more specifically, they are linear polynomials representing linear combinations of those variables. The unknown corresponding to each surrounding line segment of the non-overlapping area 13d (excluding the boundary line) is dependent on several unknowns corresponding to edges of the first plane 13a.

For example, the computation unit 12 calculates “contributions” from the boundary line of the non-overlapping area 13d to other surrounding line segments of the non-overlapping area 13d. That is, the computation unit 12 estimates physical quantities at surrounding line segments of the non-overlapping area 13d by distributing a physical quantity of the boundary line (which is indicated by the second magnetic field data 14c) to other line segments surrounding the non-overlapping area 13d. The above-noted contribution may depend on the inner product of a direction vector representing the boundary line and a direction vector representing each line segment. For example, the computation unit 12 distributes the physical quantity of the boundary line to a plurality of line segments in proportion to their respective inner products. The contribution thus takes a value of zero for line segments perpendicular to the boundary line, and a larger contribution goes to a line segment facing the boundary line.

As can be seen from the above example, each unknown of surrounding line segments of the overlapping area 13c, as well as of those non-overlapping area 13d, is expressed as an equation using edge-based variables of the first plane 13a. The computation unit 12 combines such equations given by the second magnetic field data 14c and third magnetic field data 14d, thus making it possible to express unknowns on all edges of the second plane 13b by using edge-based variables the first plane 13a. Accordingly, every edge-based unknown of the second plane 13b can be associated with those of the first plane 13a even if the second plane 13b has a non-overlapping area that does not overlap with any other element.

In operation of the above-described magnetic field simulator apparatus 10 of the first embodiment, second magnetic field data 14c is calculated for the overlapping area 13c on the basis of position data 14a and first magnetic field data 14b for a first plane 13a. Then, on the basis of this second magnetic field data 14c and relative positions of the overlapping area 13c and non-overlapping area 13d, third magnetic field data 14d is calculated for the non-overlapping area 13d. The proposed method is capable of obtaining third magnetic field data 14d in addition to second magnetic field data 14c in this way, even if some moving components in the model 13 move their relative positions and a non-overlapping area 13d is consequently produced around their boundary plane. The obtained second and third magnetic field data 14c and 14d of the second plane 13b is not defined independently of, but associated with the first magnetic field data 14b describing the first plane 13a. This means that the second plane 13b is entirely associated with the first plane 13a. The magnetic flux flow between elements having the first plane 13a and second plane 13b can be expressed properly in the model 13, which contributes to an increased accuracy of magnetic field simulation with an edge-based FEM.

### (b) Second Embodiment

This section describes a second embodiment. The second embodiment proposes a magnetic field simulator apparatus 100 that analyzes a magnetic field with an edge-based FEM to simulate a distribution of vector potential in a particular object. This magnetic field simulator apparatus 100 may be implemented on a user's client computer or a server computer. The magnetic field simulator apparatus 100 is a more specific example of the magnetic field simulator apparatus 10 discussed previously in the first embodiment.

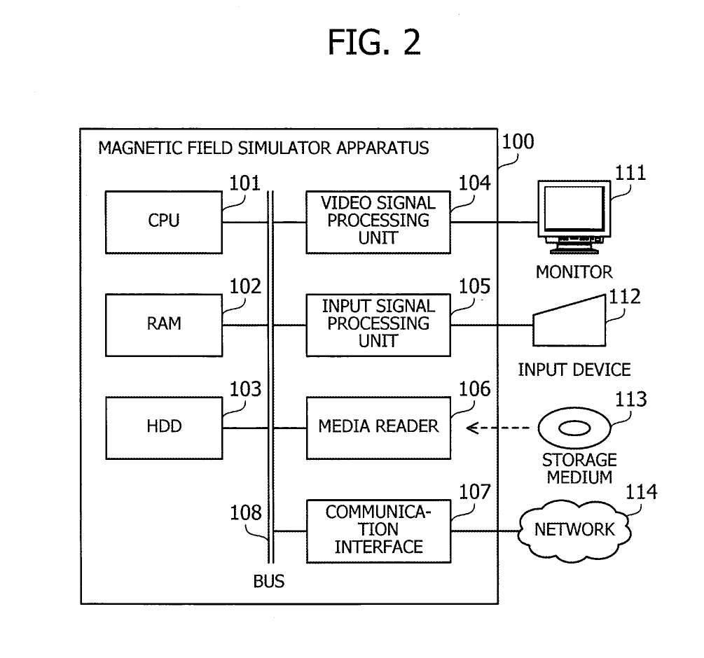

FIG. 2 is a block diagram illustrating an exemplary hardware configuration of a magnetic field simulator apparatus. The illustrated magnetic field simulator apparatus 100 includes a CPU 101, a RAM 102, an HDD 103, a video signal processing unit 104, an input signal processing unit 105, a media reader 106, and a communication interface 107. These components are each connected to a bus 108.

The CPU 101 is a processor that includes computational circuits to execute programmed instructions. Specifically, the CPU 101 reads at least part of program and data files stored in the HDD 103 and executes programs after loading them on the RAM 102. The CPU 101 may include a plurality of processor cores, and the magnetic field simulator apparatus 100 may include two or more processors. These processors or processor cores may be used to execute a plurality of processing operations (described later) in a parallel fashion. The term “processor” may be used to refer to a single processing device or a multiprocessor system including two or more processing devices.

The RAM 102 is a volatile semiconductor memory device that temporarily stores programs that the CPU 101 executes, as well as various data objects that the CPU 101 manipulates in the course of computation. Other type of memory devices may be used in place of or together with the RAM 102, and the magnetic field simulator apparatus 100 may have two or more sets of such memory devices.

The HDD 103 serves as a non-volatile storage device to store program and data files of the operating system (OS), middleware, applications, and any other kind of software. A magnetic field simulator program is stored in the HDD 103 as one of those programs. The magnetic field simulator apparatus 100 may include a plurality of non-volatile storage devices such as flash memories and solid state drives (SSD) in place of, or together with the HDD 103.

The video signal processing unit 104 produces video images in accordance with commands from the CPU 101 and outputs them on a screen of a monitor 111 coupled to the magnetic field simulator apparatus 100. The monitor 111 may be, for example, a cathode ray tube (CRT) display, liquid crystal display (LCD), plasma display panel (PDP), organic electro-luminescence (OEL) display, or other display device.

The input signal processing unit 105 receives input signals from input devices 112 and supplies them to the CPU 101. The input devices 112 include pointing devices (e.g., mouse, touchscreen, touchpad, trackball), keyboards, remote controllers, push button switches, and the like. The magnetic field simulator apparatus 100 allows connection of two or more input devices of different categories.

The media reader 106 is a device used to read programs and data stored in a storage medium 113. The storage media 113 include, for example, magnetic disk media such as flexible disk (FD) and HDD, optical disc media such as compact disc (CD) and digital versatile disc (DVD), magneto-optical discs (MO), and semiconductor memory devices. The media reader 106 transfers programs and data read out of such a storage medium 113 to, for example, the RAM 102 or HDD 103.

The communication interface 107 is connected to a network 114 for communication with remote devices. The communication interface 107 may be designed for a wired network or a wireless network (or both). In the former case, the magnetic field simulator apparatus 100 is connected to a network device (e.g., switch) via a cable. In the latter case, the magnetic field simulator apparatus 100 is linked to a base station or an access point via a radio link.

Some of the components seen in FIG. 2 may be optional. For example, the media reader 106 may be omitted. The video signal processing unit 104 and input signal processing unit 105 may also be omitted in the case where the magnetic field simulator apparatus 100 is implemented as a server computer. It may also be possible to integrate a monitor 111 and input devices 112 into the enclosure of the magnetic field simulator apparatus 100. It is further noted that the CPU 101 is an example of the computation unit 12 discussed in the first embodiment, and that the RAM 102 or HDD 103 is an example of the storage unit 11 discussed in the same.

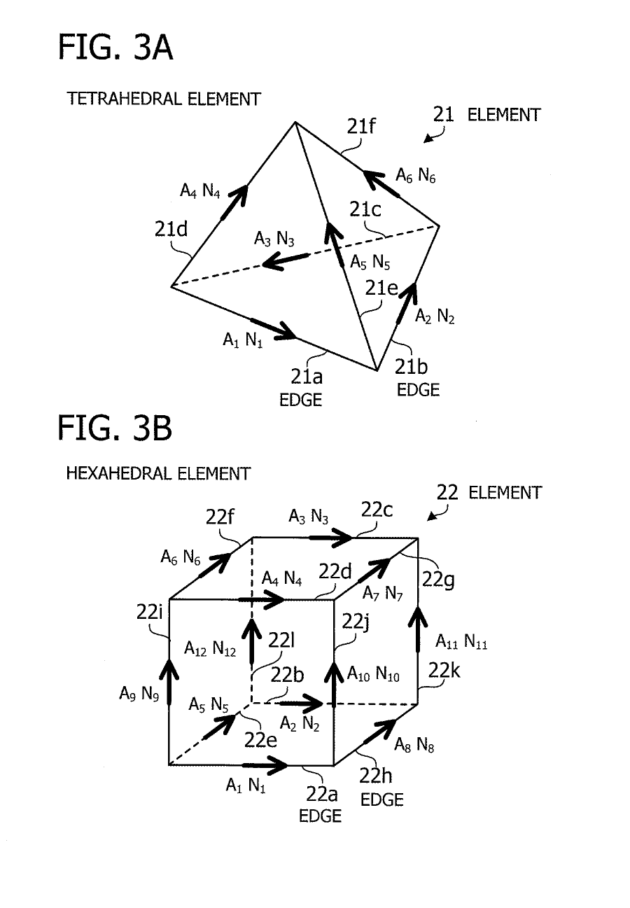

An example of magnetic field simulation using an edge-based FEM will now be described below. To begin with, FIGS. 3A and 3B illustrate examples of unknowns in an edge-based FEM. FEM generally uses a model including nodes, edges, and elements. In the case of the second embodiment, the magnetic field simulator apparatus 100 uses a three-dimensional model including these things. The term “element” in FEM means each small region into which the model space is divided. The term “node” refers to each vertex of an element, and the term “edge” each of the line segments that delineate the element. In other words, an edge connects two nodes. The term “mesh” may also be used to refer to a set of elements or each individual element.

The space of a three-dimensional model is divided into multiple elements. The resulting three-dimensional elements may include tetrahedral elements seen in FIG. 3A and hexahedral elements seen in FIG. 3B. Tetrahedral elements are each formed from four triangular planes. Hexahedral elements are each formed from six quadrangular planes. Note that the tetrahedral elements may not be regular tetrahedrons, and the hexahedral elements may not be regular hexahedrons. The magnetic field simulator apparatus 100 can handle various shapes of tetrahedral elements, hexahedral elements, or their combination.

As an example, the tetrahedral element 21 in FIG. 3A has six edges 21a, 21b, 21c, 21d, 21e, and 21f. Edges 21a, 21b, and 21c form one triangular plane. Edges 21a, 21d, and 21e form another triangular plane. Edges 21b, 21e, and 21f form yet another triangular plane. Edges 21c, 21d, and 21f form still another triangular plane.

As another example, the hexahedral element 22 in FIG. 3B has twelve edges 22a, 22b, 22c, 22d, 22e, 22f, 22g, 22h, 22i, 22j, 22k, and 22l. Edges 22a, 22b, 22e, and 22h form one quadrangular plane. Edges 22c, 22d, 22f, and 22g form another quadrangular plane. Edges 22a, 22d, 22i, and 22j form yet another quadrangular plane. Edges 22b, 22c, 22k, and 22l form still another quadrangular plane. Edges 22e, 22f, 22i, and 22l form still another quadrangular plane. Edges 22g, 22h, 22j, and 22k form still another quadrangular plane.

The edge-based FEM defines a “basis function” (also called a “basis vector”) along each edge, in the form of a unit vector (i.e., vector with a length of one). The direction of each such basis function is previously selected from two possibilities in the way described below.

For the tetrahedral element 21 of FIG. 3A, basis function N₁ is defined for one edge 21a. Note that this symbol N₁ represents a vector although no particular vector symbol (e.g., “→”) is attached. Similarly, basis functions N₂, N₃, N₄, N₅, and N₆ are defined for the other edges 21b, 21c, 21d, 21e, and 21f. For the hexahedral element 22 of FIG. 3B, basis functions N₁, N₂, N₃, N₄, N₅, N₆, N₇, N₈, N₉, N₁₀, N₁₁, and N₁₂ are defined for edges 22a, 22b, 22c, 22d, 22e, 22f, 22g, 22h, 22i, 22j, 22k, and 22l, respectively.

The edge-based FEM also defines a variable representing a scalar unknown at each edge. These variables are evaluated through execution of the edge-based FEM. The unknown at a certain edge indicates the magnitude of vector potential of the edge, and it means a coefficient by which the basis function of the edge is multiplied. That is, each edge is given a particular vector potential that is expressed as a basis function multiplied by an unknown. Vector potential A of an element as a whole is then given by combining vector potentials of the element's surrounding edges (six edges for a tetrahedral element, and twelve edges for a hexahedral element) according to the following equation (1).

$$\vec{A} = {\sum }_{n} {A}_{n} {\vec{N}}_{n} \qquad ( 1 )$$

where n is the edge number indicating a surrounding edge of an element, Aₙ represents a variable assigned to the n-th edge, and Nₙ represents a basis function of the n-th edge.

For example, variables A₁, A₂, A₃, A₄, A₅, and A₆ are defined for edges 21a, 21b, 21c, 21d, 21e, and 21f of the tetrahedral element 21 of FIG. 3A. The edges 21a, 21b, 21c, 21d, 21e, and 21f have their respective vector potentials expressed as A₁N₁, A₂N₂, A₃N₃, A₄N₄, A₅N₅, and A₆N₆. Vector potential of the tetrahedral element 21 as a whole is then obtained by combining (adding up) these vector potentials into one. For the hexahedral element 22 of FIG. 3B, variables A₁, A₂, A₃, A₄, A₅, A₆, A₇, A₈, A₉, A₁₀, A₁₁, and A₁₂ are defined for its edges 22a, 22b, 22c, 22d, 22e, 22f, 22g, 22h, 22i, 22j, 22k, and 22l, respectively. The edges 22a, 22b, 22c, 22d, 22e, 22f, 22g, 22h, 22i, 22j, 22k, and 22l have their respective vector potentials expressed as A₁N₁, A₂N₂, A₃N₃, A₄N₄, A₅N₅, A₆N₆, A₇N₇, A₈N₈, A₉N₉, A₁₀N₁₀, A₁₁N₁₁, and A₁₂N₁₂. Then the vector potential of the hexahedral element 22 as a whole is obtained by combining these vector potentials.

The magnetic field simulator apparatus 100 calculates variables of individual edges by solving the following magnetic field equation (2) in the above-described model.

$$σ \frac{\partial \vec{A}}{\partial t} + \vec{∇} \times ( \frac{1}{μ} \vec{∇} \times \vec{A} ) = \vec{J} + \frac{1}{{μ}_{0}} \vec{∇} \times \vec{M} \qquad ( 2 )$$

where σ represents dielectric constant, μ represents permeability, μ₀ represents permeability in a vacuum, J represents a current density vector, and M represents a magnetization vector of a magnet. The magnetic field simulator apparatus 100 then obtains magnetic flux densities B from the vector potential A by using equation (3).

\vec{B}=\vec{∇}×\vec{A} (3)

The magnetic field simulator apparatus 100 can simulate how the vector potential distribution varies with time-dependent relative positions of components of the object under analysis. In this course, the magnetic field simulator apparatus 100 calculates vector potential distribution at two distinct time points, without reforming the element set. However, some adjacent elements located at a boundary of components may lose their continuity because of their positional displacement and consequent loss of shared edges.

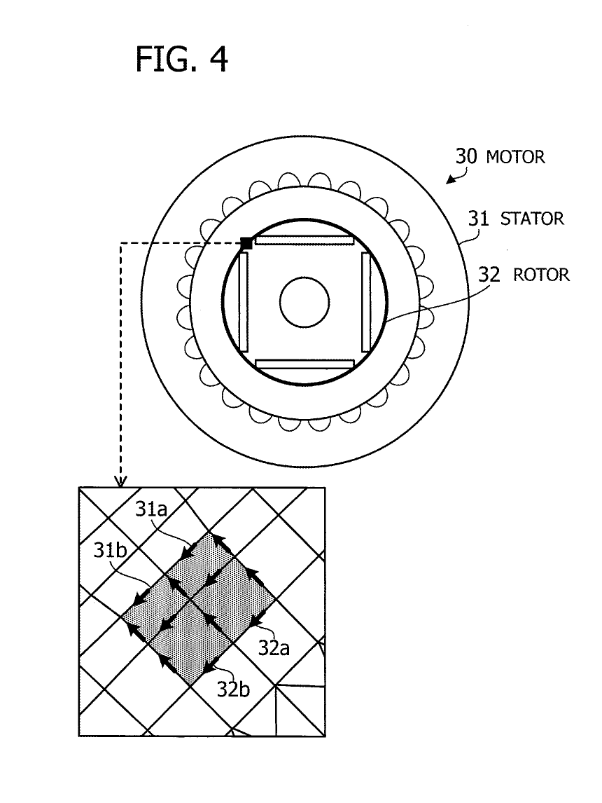

FIG. 4 illustrates an exemplary model of an electric motor. The illustrated electric motor (or simply “motor”) 30 of FIG. 4 is an example of an object under magnetic field analysis. The motor 30 includes a stator 31 and a rotor 32. The rotor 32 has a cylindrical shape and rotates around the longitudinal axis of the cylinder. The stator 31 is a stationary portion of the motor 30 that surrounds the rotor 32.

Suppose that the geometry of the motor 30 at a certain time point is divided into a plurality of elements. The produced elements include adjacent elements in a boundary region between the stator 31 and rotor 32, and these adjacent elements share some edges on the boundary plane. This means that those boundary elements of the stator 31 are continuous with those of the rotor 32. Referring to the example of FIG. 4, one element 31a of the stator 31 is adjacent to one element 32a of the rotor 32. These two elements 31a and 32a share an edge on the boundary plane and are thus deemed continuous. Likewise, another element 31b of the stator 31 is adjacent to another element 32b of the rotor 32. These two elements 31b and 32b also share an edge on the boundary plane and are thus deemed continuous.

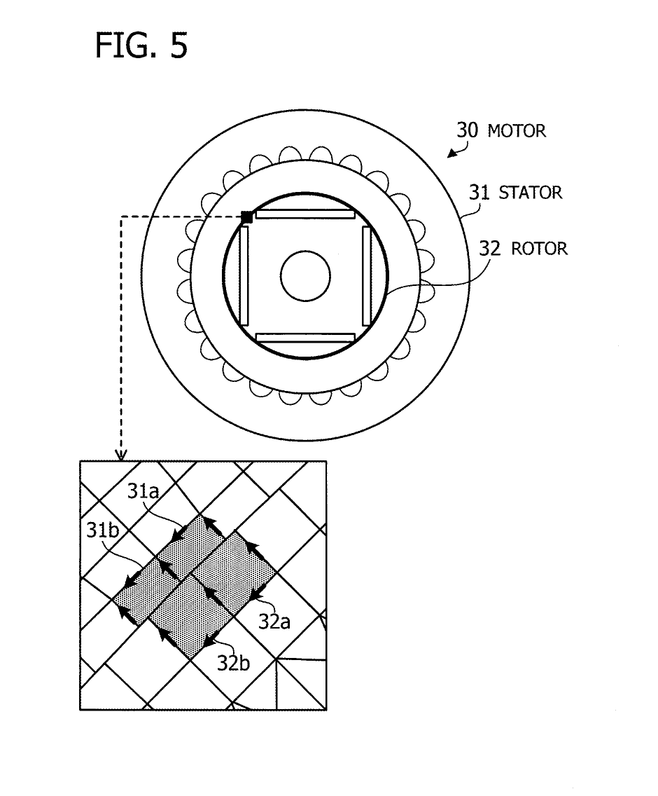

FIG. 5 illustrates an exemplary model of an electric motor that has rotated. As described above, the motor 30 has been modeled as a set of divided elements, and a rotary motion of the rotor 32 relative to the stator 31 causes a displacement of adjacent elements located in their boundary. This displacement brings about discontinuity of the adjacent elements because they are unable to share their boundary edges in that displaced state. Referring to the example of FIG. 5, one element 31a of the stator 31 is located immediately next to two elements 32a and 32b of the rotor 32, with the boundary plane in between. The former element 31a, however, does not wholly share its boundary edge with either of the latter elements 32a and 32b and is discontinuous with them. Likewise, another elements 31b of the stator 31 is located immediately next to two elements 32a and 32b of the rotor 32, with the boundary plane in between. The former element 31b also does not wholly share its boundary edge with either of the latter elements 32a and 32b and is discontinuous with them.

Think of two such discontinuous elements on the opposite sides of the boundary plane. If variables are defined at the edges of one element independently of variables of the other element, these variables in the model would not be able to properly represent a flow of magnetic flux between the elements, and the accuracy of magnetic field analysis could consequently be degraded. The proposed magnetic field simulator apparatus 100 overcomes this difficulty by expressing unknowns on one side as a linear polynomial of variables on the other side. In other words, unknowns on one side are made dependent on unknowns on the other side of the boundary plane. This technique associates the former unknowns with the latter unknowns, thus enabling more accurate representation of flux flows between boundary elements. The magnetic field simulator apparatus 100 therefore continues the magnetic field analysis with the same model although it now contains discontinuous elements. Here the planes located on the boundary are divided into two groups called “master planes” and “slave planes.” Master planes are the planes whose edges are assigned independent variables. Slave planes are the planes whose unknowns are dependent on the variables of master planes. That is, no independent variables are defined for the slave planes.

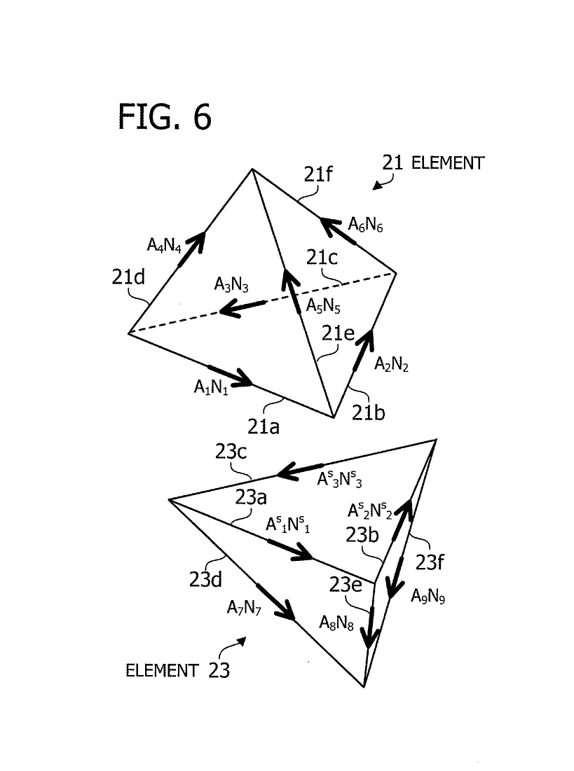

FIG. 6 illustrates an example of master-side and slave-side elements. This example assumes that the foregoing element 21 of FIG. 3A is located next to another tetrahedral element 23 having edges 23a, 23b, 23c, 23d, 23e, and 23f. Regarding the latter element 23, edges 23a, 23b, and 23c form a triangular plane. Likewise, edges 23a, 23d, and 23e form another triangular plane, edges 23b, 23e, and 23f form yet another triangular plane, and edges 23c, 23d, and 23f form still another triangular plane. The top plane of the lower element 23 (i.e., the plane formed from edges 23a, 23b, and 23c) is partly in contact with the bottom plane of the upper element 21 (i.e., the one formed from edges 21a, 21b, and 21c). These two planes, however, do not share any of their edges, and thus the elements 21 and 23 are discontinuous.

Basis functions N₇, N₈, and N₉ and variables A₇, A₈, and A₉ are defined at edges 23d, 23e, 23f of the lower element 23. That is, these edges 23d, 23e, and 23f have their vector potentials A₇N₇, A₈N₈, and A₉N₉. In contrast, basis functions N^{s}₂, N^{s}₂, and N^{s}₃ and variables A^{s}₁, A^{s}₂, and A^{s}₃ are defined at other edges 23a, 23b, and 23c since the plane of these edges is in contact with the upper element 21. The edges 23a, 23b, and 23c have their respective vector potentials A^{s}₂N^{s}₂, A^{s}₂N^{s}₂, and A^{s}₃N^{s}₃. Note that A^{s}₁, A^{s}₂, A^{s}₃ are not independent variables, but depend on the other element's variables A₁, A₂, A₃, and the like. The plane formed by edges 21a, 21b, and 21c of the upper element 21 is therefore deemed to be a master plane, while the plane formed by edges 23a, 23b, and 23c of the lower element 23 is deemed to be a slave plane.

The vector potential of the element 21 as a whole is calculated by adding up those of its six edges 21a, 21b, 21c, 21d, 21e, and 21f as seen in equation (4) below. Similarly the vector potential of the element 23 as a whole is calculated by adding up those of its edges 23a, 23b, 23c, 23d, 23e, and 23f as seen in equation (5) below. As will be discussed later in detail, each slave-plane variable A^{s}₁, A^{s}₂, and A^{s}₃ is to be replaced with a linear polynomial of variables A₁, A₂, A₃, and the like of other elements, so as to express the electro-magnetic continuity between the two elements 21 and 23.

\vec{A}=A₁\vec{N}₁+A₂\vec{N}₂+A₃\vec{N}₃+A₄\vec{N}₄+A₅\vec{N}₅+A₆\vec{N}₆ (4)

\vec{A}=A₁^{s}\vec{N}₁^{s}+A₂^{s}\vec{N}₂^{s}+A₃^{s}\vec{N}₃^{s}+A₇\vec{N}₇+A₈\vec{N}₈+A₉\vec{N}₉ (5)

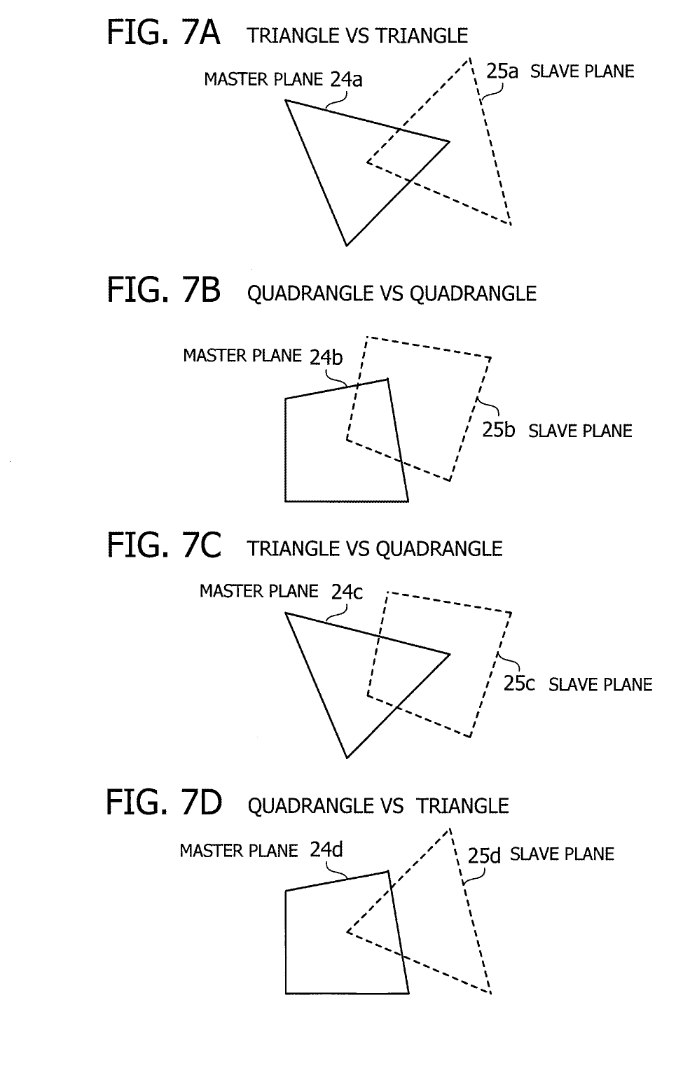

FIG. 7A to 7D illustrate various combinations of master-plane and slave-plane shapes. It is supposed now that the magnetic field simulator apparatus 100 uses tetrahedral elements formed from triangular planes as well as hexahedral elements formed from quadrangular planes. In this case, the overlapping combinations of a master plane and a slave plane are categorized into four patterns described below. Referring to the first pattern in FIG. 7A, a triangular slave plane 25a partly overlaps with a triangular master plane 24a. Referring to the second pattern in FIG. 7B, a quadrangular slave plane 25b partly overlaps with a quadrangular master plane 24b. Referring to the third pattern in FIG. 7C, a quadrangular slave plane 25c partly overlaps with a triangular master plane 24c. Referring to the fourth pattern in FIG. 7D, a triangular slave plane 25d partly overlaps with a quadrangular master plane 24d.

The following description mainly assumes the first pattern of master and slave planes (i.e., both are triangular planes) to demonstrate the proposed calculation. The same calculation policy may also apply to the second to fourth patterns.

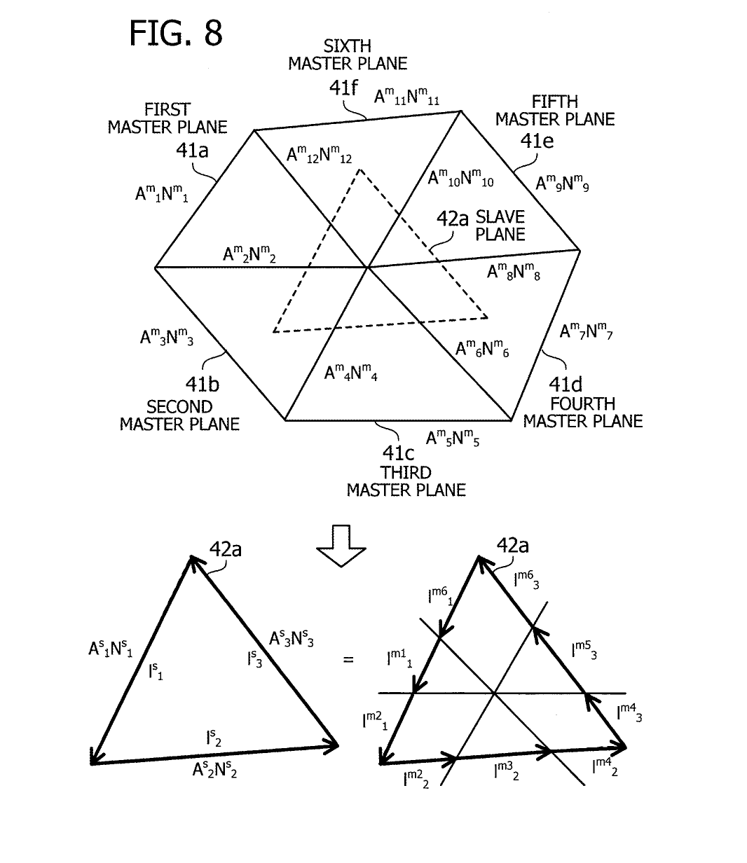

FIG. 8 illustrates a first exemplary overlap of a slave plane with master planes. In this example, one slave plane 42a overlaps with six master planes 41a, 41b, 41c, 41d, 41e, and 41f, which may respectively be referred to as first to sixth master planes. The individual master planes 41a, 41b, 41c, 41d, 41e, and 41f and slave plane 42a belong to different elements. As seen in FIG. 8, the first master plane 41a contacts with the second master plane 41b at one shared edge. The second master plane 41b contacts with the third master plane 41c at one shared edge. The third master plane 41c contacts with the fourth master plane 41d at one shared edge. The fourth master plane 41d contacts with the fifth master plane 41e at one shared edge. The fifth master plane 41e contacts with the sixth master plane 41f at one shared edge. The sixth master plane 41f contacts with the first master plane 41a at one shared edge.

The slave plane 42a partly overlaps with each of the master planes 41a, 41b, 41c, 41d, 41e, and 41f. That is, the slave plane 42a is divided into six separate regions that respectively overlap with the master planes 41a, 41b, 41c, 41d, 41e, and 41f. The slave plane 42a does not have a non-overlapping area.

The first master plane 41a is surrounded by three edges with their respective basis functions N^{m}₁, N^{m}₂, and N^{m}₁₂. The second master plane 41b is surrounded by three edges with their respective basis functions N^{m}₂, N^{m}₃, and N^{m}₄. The third master plane 41c is surrounded by three edges with their respective basis functions N^{m}₄, N^{m}₅, and N^{m}₆. The fourth master plane 41d is surrounded by three edges with their respective basis functions N^{m}₆, N^{m}₇, and N^{m}₈. The fifth master plane 41e is surrounded by three edges with their respective basis functions N^{m}₈, N^{m}₉, and N^{m}₁₀. The sixth master plane 41f is surrounded by three edges with their respective basis functions N^{m}₁₀, N^{m}₁₁, and N^{m}₁₂. Independent variables A^{m}₁, A^{m}₂, A^{m}₃, A^{m}₄, A^{m}₅, A^{m}₆, A^{m}₇, A^{m}₈, A^{m}₉, A^{m}₁₀, A^{m}₁₁, and A^{m}₁₂ are defined for different edges indicated by the basis functions N^{m}₁, N^{m}₂, N^{m}₃, N^{m}₄, N^{m}₅, N^{m}₆, N^{m}₇, N^{m}₈, N^{m}₉, N^{m}₁₀, N^{m}₁₁, and N^{m}₁₂. These variables represent unknowns to be solved by the magnetic field simulator apparatus 100.

The slave plane 42a, on the other hand, is surrounded by edges with basis functions N^{s}₁, N^{s}₂, and N^{s}₃. Variables A^{s}₁, A^{s}₂, and A^{s}₃ are defined for different edges indicated by the basis functions N^{s}₁, N^{s}₂, and N^{s}₃. These variables A^{s}₁, A^{s}₂, and A^{s}₃ are dependent variables, and individually expressed as a linear polynomial of multiple variables A^{m}₁, A^{m}₂, A^{m}₃, A^{m}₄, A^{m}₅, A^{m}₆, A^{m}₇, A^{m}₈, A^{m}₉, A^{m}₁₀, A^{m}₁₁, and A^{m}₁₂ of master planes.

The conservation law of magnetic flux may be used to obtain a relationship between master-plane variables A^{m}₁, A^{m}₂, A^{m}₃, A^{m}₄, A^{m}₅, A^{m}₆, A^{m}₇, A^{m}₈, A^{m}₉, A^{m}₁₀, A^{m}₁₁, and A^{m}₁₂ and slave-plane variables A^{s}₁, A^{s}₂, and A^{s}₃. Specifically, magnetic flux Φ is calculated as a surface integral of magnetic flux density B as seen in equation (6). Magnetic flux density B is calculated as a line integral of vector potential A.

∫ₛ\vec{B}d\vec{S}=∫ₛ(\vec{Λ}×\vec{A})\vec{n}dS= [symbol] \vec{A}d\vec{l}=Φ (6)

where dS is a small surface for integration, and n is a normal vector of that surface.

The unknown at an edge of the slave plane 42a can be obtained as a line integral of vector potential along the edge over its overlapping master planes. To express such line integrals, several line vectors are defined on each edge of the slave plane 42a as will be described below.

That is, a first line vector l^{s}₁ is defined to indicate the whole edge of basis function N^{s}₁ in the slave plane 42a. Similarly, a second line vector l^{s}₂ is defined to indicate the whole edge of basis function N^{s}₂, and a third line vector l^{s}₃ is defined to indicate the whole edge of basis function N^{s}₃. The first line vector l^{s}₁ is then divided into smaller line vectors as follows: l^{m6}₁ representing a line segment on the sixth master plane 41f, l^{m1}₁ representing a line segment on the first master plane 41a, and l^{m2}₁ representing a line segment on the second master plane 41b. Similarly, the second line vector l^{s}₂ is divided into smaller line vectors as follows: l^{m2}₂ representing a line segment on the second master plane 41b, l^{m3}₂ representing a line segment on the third master plane 41c, and l^{m4}₂ representing a line segment on the fourth master plane 41d. The third line vector l^{s}₃ is also divided into smaller line vectors as follows: l^{m4}₃ representing a line segment on the fourth master plane 41d, l^{m5}₃ representing a line segment on the fifth master plane 41e, and l^{m6}₃ representing a line segment on the sixth master plane 41f.

Line vectors have been defined in the way described above. The unknown value of variable A^{s}₁ is now obtained by line-integrating the master-plane vector potentials along line vector l^{s}₁. This line integral along l^{s}₁ can be divided into three line integrals along the following divided line vectors: l^{m6}₁ on the sixth master plane 41f, l^{m1}₁ on the first master plane 41a, and l^{m2}₁ on the second master plane 41b. Here, the vector potential in the sixth master plane 41f is given as a combination of vector potentials of edges indicated by basis functions N^{m}₁₀, N^{m}₁₁, and N^{m}₁₂. Similarly, the vector potential in the first master plane 41a is given as a combination of vector potentials of edges indicated by basis functions N^{m}₂, N^{m}₂, and N^{m}₁₂. The vector potential in the second master plane 41b is given as a combination of vector potentials of edges indicated by basis functions N^{m}₂, N^{m}₃, and N^{m}₄. Accordingly, the unknown variable A^{s}₁ in question is calculated as in equation (7) below. As seen from this equation (7), variable A^{s}₁ of the slave plane 42a can be replaced with a linear polynomial of multiple variables A^{m}₁, A^{m}₂, A^{m}₃, A^{m}₄, A^{m}₁₀, A^{m}₁₁, and A^{m}₁₂. Note that the inner product of each basis function and foregoing line vector has a specific numerical value since the coordinates of each node are known.

$$( 7 )$$

$$\begin{matrix}\int \vec{A} d \vec{{l}_{1}^{s}} = {A}_{1}^{s} \int {\vec{N}}_{1}^{s} d {\vec{l}}_{1}^{s} \\ = {A}_{1}^{s} \\ = {A}_{10}^{m} \int {\vec{N}}_{10}^{m} d {\vec{l}}_{1}^{ m 6} + {A}_{11}^{m} \int {\vec{N}}_{11}^{m} d {\vec{l}}_{1}^{ m 6} + {A}_{12}^{m} \int {\vec{N}}_{12}^{m} d {\vec{l}}_{1}^{ m 6} + \\ {A}_{1}^{m} \int {\vec{N}}_{1}^{m} d {\vec{l}}_{1}^{ m 1} + {A}_{2}^{m} \int {\vec{N}}_{2}^{m} d {\vec{l}}_{1}^{ m 1} + {A}_{12}^{m} \int {\vec{N}}_{12}^{m} d {\vec{l}}_{1}^{ m 1} + \\ {A}_{2}^{m} \int {\vec{N}}_{2}^{m} d {\vec{l}}_{1}^{ m 2} + {A}_{3}^{m} \int {\vec{N}}_{3}^{m} d {\vec{l}}_{1}^{ m 2} + {A}_{4}^{m} \int {\vec{N}}_{4}^{m} d {\vec{l}}_{1}^{ m 2}\end{matrix}$$

Similarly, the unknown value of variable A^{s}₂ is obtained by line-integrating the master-plane vector potentials along line vector l^{s}₂. This line integral along l^{s}₂ can be divided into three line integrals along the following divided line vectors: l^{m2}₂ on the second master plane 41b, l^{m3}₂ on the third master plane 41c, and l^{m4}₂ on the fourth master plane 41d. Accordingly, the unknown variable A^{s}₂ in question is calculated as in equation (8) below. This means that variable A^{s}₂ of the slave plane 42a can be replaced with a linear polynomial of multiple variables A^{m}₂, A^{m}₃, A^{m}₄, A^{m}₅, A^{m}₆, A^{m}₇, and A^{m}₈.

$$( 8 )$$

$$\begin{matrix}\int \vec{A} d \vec{{l}_{2}^{s}} = {A}_{2}^{s} \int {\vec{N}}_{2}^{s} d {\vec{l}}_{2}^{s} \\ = {A}_{2}^{s} \\ = {A}_{2}^{m} \int {\vec{N}}_{2}^{m} d {\vec{l}}_{2}^{ m 2} + {A}_{3}^{m} \int {\vec{N}}_{3}^{m} d {\vec{l}}_{2}^{ m 2} + {A}_{4}^{m} \int {\vec{N}}_{4}^{m} d {\vec{l}}_{2}^{ m 2} + \\ {A}_{4}^{m} \int {\vec{N}}_{4}^{m} d {\vec{l}}_{2}^{ m 3} + {A}_{5}^{m} \int {\vec{N}}_{5}^{m} d {\vec{l}}_{2}^{ m 3} + {A}_{6}^{m} \int {\vec{N}}_{6}^{m} d {\vec{l}}_{2}^{ m 3} + \\ {A}_{6}^{m} \int {\vec{N}}_{6}^{m} d {\vec{l}}_{2}^{ m 4} + {A}_{7}^{m} \int {\vec{N}}_{7}^{m} d {\vec{l}}_{2}^{ m 4} + {A}_{8}^{m} \int {\vec{N}}_{8}^{m} d {\vec{l}}_{2}^{ m 4}\end{matrix}$$

Further, the unknown value of variable A^{s}₃ is obtained by line-integrating the master-plane vector potentials along line vector l^{s}₃. This line integral along l^{s}₃ can be divided into three line integrals along the following divided line vectors: l^{m4}₃ on the fourth master plane 41d, l^{m5}₃ on the fifth master plane 41e, and l^{m6}₃ on the sixth master plane 41f. Accordingly, the unknown variable A^{s}₃ in question is calculated as in equation (9) below. This means that variable A^{s}₃ of the slave plane 42a can be replaced with a linear polynomial of multiple variables A^{m}₆, A^{m}₇, A^{m}₈, A^{m}₉, A^{m}₁₀, A^{m}₁₁, and A^{m}₁₂.

$$( 9 )$$

$$\begin{matrix}\int \vec{A} d \vec{{l}_{3}^{s}} = {A}_{3}^{s} \int {\vec{N}}_{3}^{s} d {\vec{l}}_{3}^{s} \\ = {A}_{3}^{s} \\ = {A}_{6}^{m} \int {\vec{N}}_{6}^{m} d {\vec{l}}_{3}^{ m 4} + {A}_{7}^{m} \int {\vec{N}}_{7}^{m} d {\vec{l}}_{3}^{ m 4} + {A}_{8}^{m} \int {\vec{N}}_{8}^{m} d {\vec{l}}_{3}^{ m 4} + \\ {A}_{8}^{m} \int {\vec{N}}_{8}^{m} d {\vec{l}}_{3}^{ m 5} + {A}_{9}^{m} \int {\vec{N}}_{9}^{m} d {\vec{l}}_{3}^{ m 5} + {A}_{10}^{m} \int {\vec{N}}_{10}^{m} d {\vec{l}}_{3}^{ m 5} + \\ {A}_{10}^{m} \int {\vec{N}}_{10}^{m} d {\vec{l}}_{3}^{ m 6} + {A}_{11}^{m} \int {\vec{N}}_{11}^{m} d {\vec{l}}_{3}^{ m 6} + {A}_{12}^{m} \int {\vec{N}}_{12}^{m} d {\vec{l}}_{3}^{ m 6}\end{matrix}$$

The above three equations (7), (8), and (9) for slave-plane variables may be generalized into equation (10) seen below.

$${A}_{n}^{s} = {\sum }_{i} {\sum }_{j} {A}_{j}^{m} {\vec{N}}_{j}^{m} d {\vec{l}}_{n}^{ mi} \qquad ( 10 )$$

where n is the edge number indicating a specific edge of the slave plane, i is the plane number indicating a specific master plane that overlaps with the slave plane in question, and j is the edge number of a specific edge of the i-th master plane. A^{s}ₙ represents the n-th edge variable of the slave plane. A^{m}ⱼ represents the j-th edge variable of the i-th master plane. N^{m}ⱼ is a basis function that indicates the j-th edge of the i-th master plane. l^{mi}ₙ is a line vector representing a line segment that is a part of the n-th edge of the slave plane and overlaps with the i-th master plane. Equation (10) associates unknowns on the slave plane with unknowns on its overlapping master planes and thus enables calculation of the former unknowns once the latter unknowns are solved.

Unknowns at the edges of a slave plane can be calculated with equations (7), (8), (9), and (10) described above when the entire slave plane overlap with one or more master planes. These equations (7), (8), (9), and (10) may, however, not be applied as is to the case in which the slave place further has a non-overlapping area against any of its master planes, because it is not possible to simply line-integrate vector potentials for a part of the slave-plane edges. The next part of the description will now go into details of how unknowns are calculated in such cases.

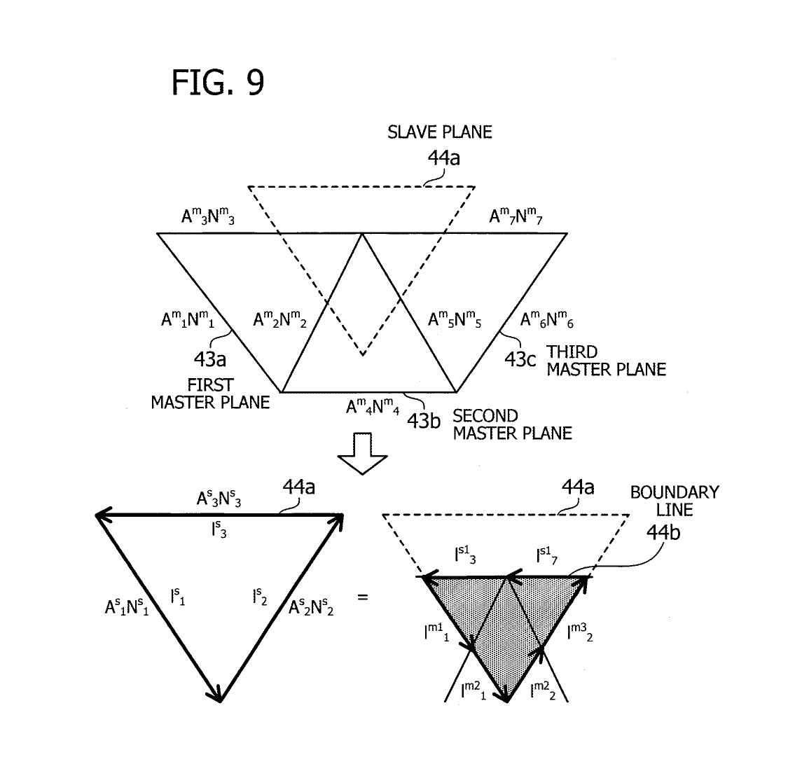

FIG. 9 illustrates a second exemplary overlap of a slave plane with master planes. Here a slave plane 44a is partly overlaps with first to third master planes 43a, 43b, and 43c. The individual master planes 43a, 43b, and 43c and slave plane 44a belong to different elements. The first master plane 43a contacts with the second master plane 43b at one shared edge. The second master plane 43b contacts with the third master plane 43c at one shared edge. The slave plane 44a overlaps with each of those master planes 43a, 43b, and 43c. That is, the slave plane 44a includes three regions respectively overlapping with the individual master planes 43a, 43b, and 43c. The slave plane 44a also has a non-overlapping region that is shared with neither of those master planes 43a, 43b, and 43c nor any other plane.

The first master plane 43a is surrounded by edges with basis functions N^{m}₁, N^{m}₂, and N^{m}₃. The second master plane 43b is surrounded by edges with basis functions N^{m}₂, N^{m}₄, and N^{m}₅. The third master plane 43c is surrounded by edges with basis functions N^{m}₅, N^{m}₆, and N^{m}₇. Independent variables A^{m}₁, A^{m}₂, A^{m}₃, A^{m}₄, A^{m}₅, A^{m}₆, and A^{m}₇ are defined for different edges indicated by the basis functions N^{m}₁, N^{m}₂, N^{m}₃, N^{m}₄, N^{m}₅, N^{m}₆, and N^{m}₇. These variables represent unknowns to be solved by the magnetic field simulator apparatus 100. The slave plane 44a, on the other hand, is surrounded by edges with basis functions N^{s}₁, N^{s}₂, and N^{s}₃, and variables A^{s}₁, A^{s}₂, and A^{s}₃ are defined for different edges indicated by the basis functions N^{s}₁, N^{s}₂, and N^{s}₃. These variables A^{s}₁, A^{s}₂, and A^{s}₃ are dependent variables and individually expressed as a linear polynomial of multiple variables A^{m}₁, A^{m}₂, A^{m}₃, A^{m}₄, A^{m}₅, A^{m}₆, and A^{m}₇ of master planes.

Line vectors are defined over the edges of the slave plane 44a similarly to the case of FIG. 8. That is, a first line vector l^{s}₁ is defined to indicate the whole edge of basis function N^{s}₁ in the slave plane 44a. Likewise, a second line vector l^{s}₂ is defined to indicate the whole edge of basis function N^{s}₂, and a third line vector l^{s}₃ is defined to indicate the whole edge of basis function N^{s}₃.

Referring now to the overlapping area (hatched in FIG. 9) of the slave plane 44a and master planes 43a, 43b, and 43c, more line vectors are defined along its surrounding line segments in the way described below. What is defined on the edge of line vector l^{s}₁ is a line vector l^{m1}₁ overlapping with the first master plane 43a and another line vector l^{m2}₁ overlapping with the second master plane 43b. What is defined on the edge of line vector l^{s}₂ is a line vector l^{m2}₂ overlapping with the second master plane 43b and another line vector l^{m3}₂ overlapping with the third master plane 43c.

A boundary line 44b is also drawn to demarcate the overlapping area from the non-overlapping area of the slave plane 44a. What is defined on this boundary line 44b is a line vector l^{s1}₃ overlapping with an edge of the first master plane 43a and another line vector l^{s1}₇ overlapping with an edge of the third master plane 43c.

The above-defined line vectors are used to calculate vector potentials for the overlapping area of the slave plane 44a. That is, the vector potential of each line segment that overlaps with one master plane is obtained by line-integrating vector potentials of the overlapping master plane along a line vector corresponding to that line segment. This calculation method, however, does not readily work for the remaining line segments of the slave plane 44a because they have no overlap with the master planes 43a, 43b, and 43c and thus receive no direct effects from them. One thing to note here is that the boundary line 44b provides some “contribution” to the vector potentials in those non-overlapping line segments of the slave plane 44a.

Equation (11) for unknown variable A^{s}₁ includes line integrals along line vector l^{m1}₁ over the first master plane 43a and line integrals along line vector l^{m2}₁ over the second master plane 43b. Also included is a contribution term (expressed as a new variable A^{s*}₁) from the boundary line 44b to the non-overlapping part of line vector l^{s}₁. The sum of these line integrals and contribution term gives the unknown value of A^{s}₁. The vector potential in the first master plane 43a is given as a combination of vector potentials of edges indicated by basis functions N^{m}₁, N^{m}₂, and N^{m}₃. The vector potential in the second master plane 43b is given as a combination of vector potentials of edges indicated by basis functions N^{m}₂, N^{m}₄, and N^{m}₅.

$$( 11 )$$

$$\begin{matrix}\int \vec{A} d \vec{{l}_{1}^{s}} = {A}_{1}^{s} \int {\vec{N}}_{1}^{s} d {\vec{l}}_{1}^{s} \\ = {A}_{1}^{s} \\ = {A}_{1}^{m} \int {\vec{N}}_{1}^{m} d {\vec{l}}_{1}^{ m 1} + {A}_{2}^{m} \int {\vec{N}}_{2}^{m} d {\vec{l}}_{1}^{ m 1} + {A}_{3}^{m} \int {\vec{N}}_{3}^{m} d {\vec{l}}_{1}^{ m 1} + \\ {A}_{2}^{m} \int {\vec{N}}_{2}^{m} d {\vec{l}}_{1}^{ m 2} + {A}_{4}^{m} \int {\vec{N}}_{4}^{m} d {\vec{l}}_{1}^{ m 2} + {A}_{5}^{m} \int {\vec{N}}_{5}^{m} d {\vec{l}}_{1}^{ m 2} + \\ {A}_{1}^{s *}\end{matrix}$$

Equation (12) for unknown variable A^{s}₂ includes line integrals along line vector l^{m2}₂ over the second master plane 43b and line integrals along line vector l^{m3}₂ over the third master plane 43c. Also included is a contribution term (expressed as a new variable A^{s*}₂) from the boundary line 44b to the non-overlapping part of line vector l^{s}₂. The sum of these line integrals and contribution term gives the unknown value of A^{s}₂. The vector potential in the second master plane 43b is given as a combination of vector potentials of edges represented by basis functions N^{m}₂, N^{m}₄, and N^{m}₅. The vector potential in the third master plane 43c is given as a combination of vector potentials of edges represented by basis functions N^{m}₅, N^{m}₆, and N^{m}₇.

$$( 12 )$$

$$\begin{matrix}\int \vec{A} d \vec{{l}_{2}^{s}} = {A}_{2}^{s} \int {\vec{N}}_{2}^{s} d {\vec{l}}_{2}^{s} \\ = {A}_{2}^{s} \\ = {A}_{2}^{m} \int {\vec{N}}_{2}^{m} d {\vec{l}}_{2}^{ m 2} + {A}_{4}^{m} \int {\vec{N}}_{4}^{m} d {\vec{l}}_{2}^{ m 2} + {A}_{5}^{m} \int {\vec{N}}_{5}^{m} d {\vec{l}}_{2}^{ m 2} + \\ {A}_{5}^{m} \int {\vec{N}}_{5}^{m} d {\vec{l}}_{2}^{ m 3} + {A}_{6}^{m} \int {\vec{N}}_{6}^{m} d {\vec{l}}_{2}^{ m 3} + {A}_{7}^{m} \int {\vec{N}}_{7}^{m} d {\vec{l}}_{2}^{ m 3} + \\ {A}_{2}^{s *}\end{matrix}$$

Unlike the above two edges of the slave plane 44a, the topmost edge with basis function N^{s}₃ is not directly affected by the master planes 43a, 43b, and 43c in terms of vector potential. Equation (13) for this edge thus includes only a contribution term from the boundary line 44b. That is, the unknown variable A^{s}₃ is expressed by a contribution term alone (expressed as a new variable A^{s*}₃) from the boundary line 44b to the entire edge of line vector l^{s}₃ as seen in equation (13).

∫\vec{A}d\vec{l}₃^{s}=A₃^{s}∫\vec{N}₃^{s}d\vec{l}₃^{s}=A₃^{s}=A₃^{s*} (13)

During the course of calculating three unknown variables A^{s}₁, A^{s}₂, and A^{s}₃ of the triangular slave plane 44a, the magnetic field simulator apparatus 100 has to calculate a line integral of vector potentials along the boundary line 44b between the overlapping and non-overlapping areas. This line integral is a sum of individual line integrals along two line vectors l^{s1}₃ and l^{s1}₇. The line integral along the former line vector l^{s1}₃ is calculated using interpolation from unknown variable A^{m}₃ of the first master plane 43a in accordance with the length ratio of the pertinent edge line segment (i.e., line vector l^{s1}₃ in question) to the entire edge of basis function N^{m}₃. The line integral along the latter line vector l^{s1}₇ is similarly calculated with interpolation from unknown variable A^{m}₇ of the third master plane 43c in accordance with the length ratio of the pertinent edge line segment (i.e., line vector l^{s1}₇ in question) to the entire edge of basis function N^{m}₇.

The above aside, the line integral along the boundary line 44b may also be expressed as a sum of three distributions (referred to as first to third distributions) to a non-overlapping part of the slave plane 44a from its surrounding areas. Specifically, the first distribution is from the edge of basis function N^{s}₁. The second distribution is from the edge of basis function N^{s}₂. The third distribution is from the edge of basis function N^{s}₃. More specifically, the first distribution is calculated by multiplying a line integral of basis function N^{s}₁ along the boundary line 44b by variable A^{s*}₁. The second distribution is calculated by multiplying a line integral of basis function N^{s}₂ along the boundary line 44b by variable A^{s*}₂. The third distribution is calculated by multiplying a line integral of basis function N^{s}₃ along the boundary line 44b by variable A^{s*}₃. Each line integral along the boundary line 44b is divided into two line integrals, one for line vector l^{s1}₃ and the other for line vector l^{s1}₇. The following equation (14) is thus obtained for calculation of the noted line integral along the boundary line 44b. Here the line vector lₘₑ represents a sum of two line vectors l^{s1}₃ and l^{s1}₇.

$$( 14 )$$

$$\begin{matrix}{\int }_{{l}_{3}^{s 1} + {l}_{7}^{s 1}} \vec{A} d \vec{l} = {A}_{3}^{m} \frac{\vert {l}_{3}^{s 1} \vert}{\vert {l}_{3}^{m} \vert} + {A}_{7}^{m} \frac{\vert {l}_{7}^{s 1} \vert}{\vert {l}_{7}^{m} \vert} \\ = {A}_{1}^{s *} \int {\vec{N}}_{1}^{s} d {\vec{l}}_{3}^{ s 1} + {A}_{2}^{s *} \int {\vec{N}}_{2}^{s} d {\vec{l}}_{3}^{ s 1} + {A}_{3}^{s *} \int {\vec{N}}_{3}^{s} d {\vec{l}}_{3}^{ s 1} + \\ {A}_{1}^{s *} \int {\vec{N}}_{1}^{s} d {\vec{l}}_{7}^{ s 1} + {A}_{2}^{s *} \int {\vec{N}}_{2}^{s} d {\vec{l}}_{7}^{ s 1} + {A}_{3}^{s *} \int {\vec{N}}_{3}^{s} d {\vec{l}}_{7}^{ s 1} \\ = {A}_{1}^{s *} \int {\vec{N}}_{1}^{s} d {\vec{l}}_{me}^{ } + {A}_{2}^{s *} \int {\vec{N}}_{2}^{s} d {\vec{l}}_{me}^{ } + {A}_{3}^{s *} \int {\vec{N}}_{3}^{s} d {\vec{l}}_{me}^{ }\end{matrix}$$

$$where {\vec{l}}_{me}^{ } = {\vec{l}}_{3}^{ s 1} + {\vec{l}}_{7}^{ s 1}$$

The following equation (15) for the boundary line integral is then obtained by generalizing the above equation (14). In this equation (15), k is the edge number of a master-plane edge overlapping with the boundary line 44b, i is the plane number of the slave plane in question, and j is the edge number of a specific edge of the i-th slave plane. Accordingly, A^{m}ₖ represents a vector potential of the k-th master-plane edge, and l^{si}ₖ represents a line vector indicating a line segment of the slave plane which overlaps with the k-th master-plane edge. A^{s*}ⱼ represents a contribution from the boundary line 44b to the j-th edge of the slave plane. N^{s}ⱼ represents a basis function of the j-th edge of the slave plane.

$${\sum }_{k} \int {\vec{A}}_{k}^{m} d {\vec{l}}_{k}^{ si} = {\sum }_{j} \int {A}_{j}^{s *} {\vec{N}}_{j}^{s} d {\vec{l}}_{me}^{ } \qquad ( 15 )$$

The problem at this moment is how to distribute the line integral along the boundary line 44b to a plurality of line segments constituting a non-overlapping area of the slave plane 44a. Since neither of the above two equations (14) and (15) per se provides a unique solution for this problem, it is not possible to express each variable A^{s*}₁, A^{s*}₂, and A^{s*}₃ in the form of a linear combination (linear polynomial) of variables A^{m}₃ and A^{m}₇. For this reason, the following calculation assumes that the contribution from the boundary line 44b to each line segment is proportional to a line integral of basis function N^{s}ⱼ along the boundary line 44b. Under this assumption, the values of these variables A^{s*}₁, A^{s*}₂, and A^{s*}₃ are given by the following equations (16).

A₁^{s*}=t∫\vec{N}₁^{s}d\vec{l}ₘₑ

A₂^{s*}=t∫\vec{N}₂^{s}d\vec{l}ₘₑ

A₃^{s*}=t∫\vec{N}₃^{s}d\vec{l}ₘₑ (16)

where t is a parameter that serves as a scaling factor for the line integral of basis function N^{s}.

Equation (17) is then obtained by assigning equations (16) to equation (14). Parameter t is calculated according to equation (18). This equation (18) is generalized in the same way as equation (15), thus obtaining equation (19) for parameter t. In this equation (19), k is the edge number of a master-plane edge that overlaps with the boundary line 44b, i is the plane number of the slave plane in question, and j is the edge number of a specific edge of the i-th slave plane, as previously noted for equation (15).

$$\begin{matrix}{A}_{3}^{m} \frac{\vert {l}_{3}^{s 1} \vert}{\vert {l}_{3}^{m} \vert} + {A}_{7}^{m} \frac{\vert {l}_{7}^{s 1} \vert}{\vert {l}_{7}^{m} \vert} = t \{ {( \int {\vec{N}}_{1}^{s} d {\vec{l}}_{me}^{ } )}^{2} + {( \int {\vec{N}}_{2}^{s} d {\vec{l}}_{me}^{ } )}^{2} + {( \int {\vec{N}}_{3}^{s} d {\vec{l}}_{me}^{ } )}^{2} \} & ( 17 ) \\ t = \frac{{A}_{3}^{m} \frac{\vert {l}_{3}^{s 1} \vert}{\vert {l}_{3}^{m} \vert} + {A}_{7}^{m} \frac{\vert {l}_{7}^{s 1} \vert}{\vert {l}_{7}^{m} \vert}}{{( \int {\vec{N}}_{1}^{s} d {\vec{l}}_{me}^{ } )}^{2} + {( \int {\vec{N}}_{2}^{s} d {\vec{l}}_{me}^{ } )}^{2} + {( \int {\vec{N}}_{3}^{s} d {\vec{l}}_{me}^{ } )}^{2}} & ( 18 ) \\ t = \frac{{\sum }_{k} {\vec{A}}_{k}^{m} d {\vec{l}}_{k}^{ si}}{{\sum }_{j} {( \int {\vec{N}}_{j}^{s} d {\vec{l}}_{me}^{ } )}^{2}} & ( 19 )\end{matrix}$$

After all, variable A^{s}₁ of the slave plane 44a can be expressed as a linear polynomial of master-plane variables A^{m}₁, A^{m}₂, A^{m}₃, A^{m}₄, A^{m}₅, and A^{m}₇ as seen from equation (20) below. Likewise, variable A^{s}₂ of the slave plane 44a can be expressed as a linear polynomial of master-plane variables A^{m}₂, A^{m}₃, A^{m}₄, A^{m}₅, A^{m}₆, and A^{m}₇ as seen from equation (21) below. Variable A^{s}₃ of the slave plane 44a can be expressed as a linear polynomial of master-plane variables A^{m}₃ and A^{m}₇ of pertinent master planes as seen from equation (22) below. Note that parameter t in these equations (20), (21), and (22) is given as a linear polynomial of master-plane variables A^{m}₃ and A^{m}₇ as seen from equation (18). Therefore, each equation (20), (21) and (22) actually includes the terms of variables A^{m}₃ and A^{m}₇.

$$\begin{matrix}{A}_{1}^{s} = {A}_{1}^{m} \int {\vec{N}}_{1}^{m} d {\vec{l}}_{1}^{ m 1} + {A}_{2}^{m} \int {\vec{N}}_{2}^{m} d {\vec{l}}_{1}^{ m 1} + {A}_{3}^{m} \int {\vec{N}}_{3}^{m} d {\vec{l}}_{1}^{ m 1} + {A}_{2}^{m} \int {\vec{N}}_{2}^{m} d {\vec{l}}_{1}^{ m 2} + {A}_{4}^{m} \int {\vec{N}}_{4}^{m} d {\vec{l}}_{1}^{ m 2} + {A}_{5}^{m} \int {\vec{N}}_{5}^{m} d {\vec{l}}_{1}^{ m 2} + t \int {\vec{N}}_{1}^{s} d {\vec{l}}_{me} & ( 20 ) \\ {A}_{2}^{s} = {A}_{2}^{m} \int {\vec{N}}_{2}^{m} d {\vec{l}}_{2}^{ m 2} + {A}_{4}^{m} \int {\vec{N}}_{4}^{m} d {\vec{l}}_{2}^{ m 2} + {A}_{5}^{m} \int {\vec{N}}_{5}^{m} d {\vec{l}}_{2}^{ m 2} + {A}_{5}^{m} \int {\vec{N}}_{5}^{m} d {\vec{l}}_{2}^{ m 3} + {A}_{6}^{m} \int {\vec{N}}_{6}^{m} d {\vec{l}}_{2}^{ m 3} + {A}_{7}^{m} \int {\vec{N}}_{7}^{m} d {\vec{l}}_{2}^{ m 3} + t \int {\vec{N}}_{2}^{s} d {\vec{l}}_{me} & ( 21 ) \\ {A}_{3}^{s} = t \int {\vec{N}}_{3}^{s} d {\vec{l}}_{me} & ( 22 )\end{matrix}$$

By generalizing the above equations (20), (21), and (22), the following equation (23) is obtained for unknowns of the slave plane 44a.

$${A}_{n}^{s} = {\sum }_{i} {\sum }_{j} {A}_{j}^{m} {\vec{N}}_{j}^{m} d {\vec{l}}_{n}^{ mi} + \frac{\int {\vec{N}}_{n}^{s} d {\vec{l}}_{me} {\sum }_{k} {\vec{A}}_{k}^{m} d {\vec{l}}_{me}}{{\sum }_{j} {( \int {\vec{N}}_{j}^{s} d {\vec{l}}_{me} )}^{2}} \qquad ( 23 )$$

The next description will explain some particular effects of the calculation method of “contributions” discussed above, using a new example of overlapping master and slave planes. In this example, the master planes and slave planes are both quadrangles, and some slave planes have one or more edges running perpendicularly to the boundary line.

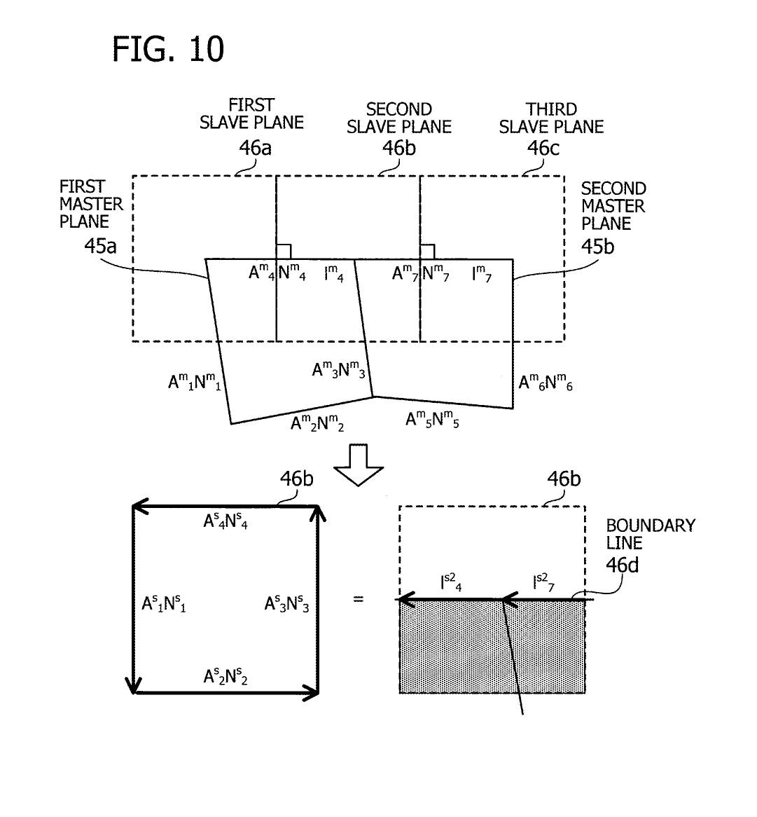

FIG. 10 illustrates a third exemplary overlap of a slave plane with master planes. First and second master planes 45a and 45b partly overlap with first to third slave planes 46a, 46b, and 46c. These master planes 45a and 45b and slave planes 46a, 46b, and 46c belong to different elements, and all of them are quadrangular. The first master plane 45a contacts with the second master plane 45b in one shared edge. The first slave plane 46a contacts with the second slave plane 46b in one shared edge. The second slave plane 46b also contacts with the third slave plane 46c in one shared edge.

The first slave plane 46a partly overlaps with the first master plane 45a. In other words, the first slave plane 46a is formed from an overlapping area over the first master plane 45a and a non-overlapping area that has no overlap with any master plane. The second slave plane 46b partly overlaps with both the master planes 45a and 45b. That is, the second slave plane 46b is formed from an overlapping area over the first master plane 45a, another overlapping area over the second master plane 45b, and a non-overlapping area that has no overlap with any master plane. The third slave plane 46c partly overlaps with the second master plane 45b. That is, the third slave plane 46c is formed from an overlapping area over the second master plane 45b and a non-overlapping area that has no overlap with any master plane.

The first master plane 45a is surrounded by edges with basis functions N^{m}₁, N^{m}₂, N^{m}₃, and N^{m}₄. The second master plane 45b is surrounded by edges with basis functions N^{m}₃, N^{m}₅, N^{m}₆, and N^{m}₇. Independent variables A^{m}₁, A^{m}₂, A^{m}₃, A^{m}₄, A^{m}₅, A^{m}₆, and A^{m}₇ are defined for different edges indicated by the basis functions N^{m}₁, N^{m}₂, N^{m}₃, N^{m}₄, N^{m}₅, N^{m}₆, and N^{m}₇. These variables represent unknowns to be solved by the magnetic field simulator apparatus 100. The second slave plane 46b is surrounded by edges with basis functions N^{s}₁, N^{s}₂, N^{s}₃, and N^{s}₄, and variables A^{s}₁, A^{s}₂, A^{s}₃, and A^{s}₄ are defined for different edges indicated by the basis functions N^{s}₁, N^{s}₂, N^{s}₃, and N^{s}₄. These slave-plane variables A^{s}₁, A^{s}₂, A^{s}₃, and A^{s}₄ are dependent variables and individually expressed as a linear polynomial of multiple variables A^{m}₁, A^{m}₂, A^{m}₃, A^{m}₄, A^{m}₅, A^{m}₆, and A^{m}₇ of master planes. The following description focuses on the second slave plane 46b, while omitting discussion about the other slave planes 46a and 46c.

A line vector l^{m}₄ is defined to represent the whole edge with basis function N^{m}₄ in the first master plane 45a. Likewise, another line vector l^{m}₇ is defined to represent the whole edge with basis function N^{m}₇. The second slave plane 46b is divided into an overlapping area and a non-overlapping area by a line segment called a boundary line 46d. This boundary line 46d runs perpendicularly to two edges indicated by basis functions N^{s}₁ and N^{s}₃ of the second slave plane 46b. The boundary line 46d is formed from two line segments. One line segment overlaps with an edge of the first master plane 45a and is indicated by a line vector l^{s2}₄. The other line segment overlaps with an edge of the second master plane 45b and is indicated by another line vector l^{s2}₇. The sum of these line vectors l^{s2}₄ and l^{s2}₇ is referred to as a line vector lₘₑ.

With the foregoing method, a line integral along the boundary line 46d is calculated as in equation (24). This line integral is a sum of individual line integrals along two line vectors l^{s2}₄ and l^{s2}₇. The line integral along the former line vector l^{s2}₄ is calculated with interpolation of an unknown variable A^{m}₄ of the first master plane 45a in accordance with the length ratio of line vector l^{s2}₄ to line vector l^{m}₄. Likewise, the line integral along the latter line vector l^{s2}₇ is calculated with interpolation of an unknown variable A^{m}₇ of the second master plane 45b in accordance with the length ratio of line vector l^{s2}₇ to line vector l^{m}₇.

The line integral along the boundary line 46d is also expressed as a sum of three distributions (referred to as first to third distributions) to a non-overlapping part of the second slave plane 46b from its surrounding areas. Specifically, the first distribution is from the edge of basis function N^{s}₁. The second distribution is from the edge of basis function N^{s}₃. The third distribution is from the edge of basis function N^{s}₄. More specifically, the first distribution is calculated by multiplying a line integral of basis function N^{s}₁ along the boundary line 46d by variable A^{s*}₁. The second distribution is calculated by multiplying a line integral of basis function N^{s}₃ along the boundary line 46d by variable A^{s*}₃. The third distribution is calculated by multiplying a line integral of basis function N^{s}₄ along the boundary line 46d by variable A^{s*}₄.

$$\begin{matrix}{\int }_{{l}_{4}^{s 2} + {l}_{7}^{s 2}} \vec{A} d \vec{l} = {A}_{4}^{m} \frac{\vert {l}_{4}^{s 2} \vert}{\vert {l}_{4}^{m} \vert} + {A}_{7}^{m} \frac{\vert {l}_{7}^{s 2} \vert}{\vert {l}_{7}^{m} \vert} \\ = {A}_{1}^{s *} \int {\vec{N}}_{1}^{s} d {\vec{l}}_{me} + {A}_{3}^{s *} \int {\vec{N}}_{3}^{s} d {\vec{l}}_{me} + {A}_{4}^{s *} \int {\vec{N}}_{4}^{s} d {\vec{l}}_{me}\end{matrix} \\ where {\vec{l}}_{me} = {\vec{l}}_{4}^{ s 3} + {\vec{l}}_{7}^{ s 2} \qquad ( 24 )$$

Because the edge of basis function N^{s}₁ is perpendicular to the boundary line 46d, the inner product between basis function N^{s}₁ and line vector lₘₑ is zero. This is also true for basis function N^{s}₃ and its inner product with line vector lₘₑ. Accordingly, the line integral of basis function N^{s}₁ along the boundary line 46d is zero, as is the line integral of basis function N^{s}₃. Equation (25) below indicates this fact. As mentioned before, the value of variable A^{s*}₁, is supposed to be proportional to such line integrals. Variables A^{s*}₁ and A^{s*}₃ are both zero for this reason. After all, the boundary line 46d contributes only to the edge of basis function N^{s}₄, which runs in parallel with the boundary line 46d.

∫\vec{N}₁^{s}d\vec{l}ₘₑ=∫\vec{N}₃^{s}d\vec{l}ₘₑ=0 (25)

The edge of basis function N^{s}₁ is shared by two slave planes 46a and 46b. If a large contribution was given from the boundary line 46d to this edge, it would affect the magnetic flux in the first slave plane 46a. The edge of basis function N^{s}₃ is shared by two slave planes 46b and 46c. If a large contribution was given from the boundary line 46d to this edge, it would affect the magnetic flux on the third slave plane 46c. The foregoing calculation method is likely to evaluate smaller contributions from the boundary line 46d to these perpendicular edges of basis functions N^{s}₁ and N^{s}₃, in contrast to a larger contribution from the boundary line 46d to the parallel edge of basis function N^{s}₄. In other words, the foregoing calculation method prevents the second slave plane 46b from affecting the magnetic flux in its adjacent slave planes 46a and 46c.

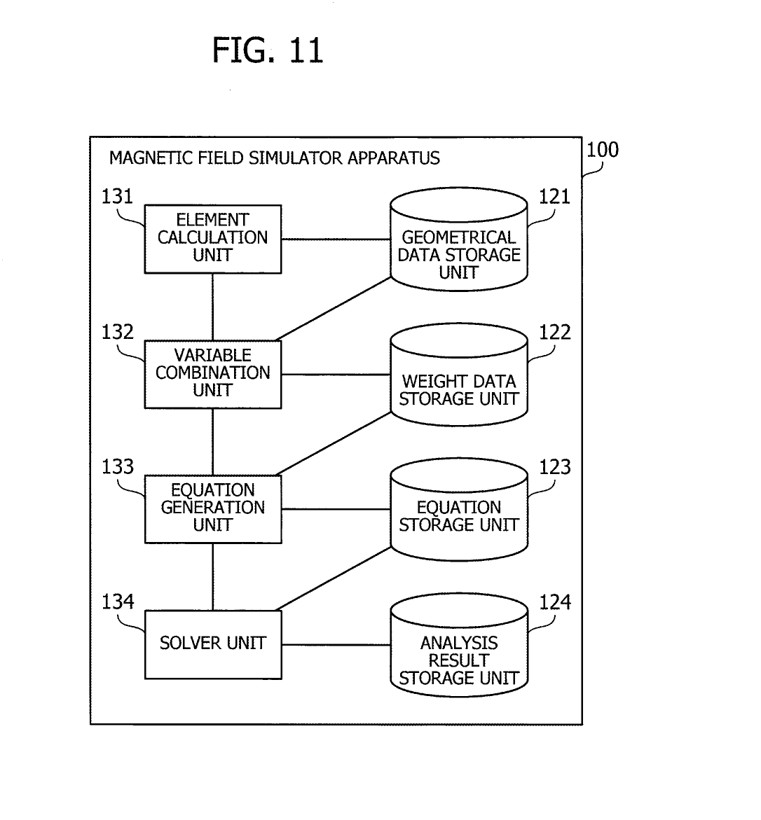

The description now turns to simulation functions of the magnetic field simulator apparatus 100. FIG. 11 is a block diagram illustrating an example of functions implemented in the proposed magnetic field simulator apparatus. This magnetic field simulator apparatus 100 includes a geometrical data storage unit 121, a weight data storage unit 122, an equation storage unit 123, an analysis result storage unit 124, an element calculation unit 131, a variable combination unit 132, an equation generation unit 133, and a solver unit 134. The geometrical data storage unit 121, weight data storage unit 122, equation storage unit 123, and analysis result storage unit 124 may be implemented as storage spaces reserved in the RAM 102 or HDD 103, for example. The element calculation unit 131, variable combination unit 132, equation generation unit 133, and solver unit 134 may be implemented as, for example, program modules to be executed by the CPU 101.

The geometrical data storage unit 121 stores geometrical data that describes the geometry of a model. The model is divided into a plurality of elements. The geometrical data includes data of nodes, edges, and planes to describe the shape and position of each element. The task of dividing the model into elements may be performed previously by the user of the magnetic field simulator apparatus 100 or by the element calculation unit 131. In the former case, the user produces geometrical data describing each node, edge, and plane of the model and sends it into the geometrical data storage unit 121. In the latter case, the user produces geometrical data describing the geometry of an object as a whole and sends it into the geometrical data storage unit 121, and the element calculation unit 131 then follows up this geometrical data by adding node data, edge data, and plane data.

The weight data storage unit 122 provides a storage space for weight data that associates unknowns in slave planes with those in master planes. More specifically, the weight data indicates the weight of each variable in linear polynomials representing slave-plane unknowns using master-plane variables. Such weight data is produced by a variable combination unit 132 described later.

The equation storage unit 123 provides a storage space for simultaneous equations to be solved for unknowns at element edges. These simultaneous equations are expressed in the form of a coefficient matrix (i.e., an array of coefficients in the equations). Such simultaneous equations are produced by the equation generation unit 133 described later.

The analysis result storage unit 124 provides a storage space for result data of an edge-based FEM analysis. The result data includes the value of each edge-based unknown calculated by solving simultaneous equations. Such result data is produced by the solver unit 134 described later.

The element calculation unit 131 divides a model into small elements in consideration of its entire shape when the model is stored in the geometrical data storage unit 121 in its original non-divided state. To define the shape and position of an element, the element calculation unit 131 first places nodes, draws edges to connect the nodes, produces each plane from multiple nodes, and determines an element formed from those planes. The elements may take the form of a tetrahedron having triangular surfaces or a hexahedron having quadrangular surfaces. The model of an object may include elements having different shapes depending on which regions of the object they represent.

The modeled object may include a movable component, such as the rotor 32 discussed in FIG. 4. When this is the case, the element calculation unit 131 implements a movement of the component on the model. Here the user may specify the direction of the movement, as well as a unit distance or angle per movement.

The variable combination unit 132 works when the element calculation unit 131 has modified the model with a component movement. In response, the variable combination unit 132 reads the modified model out of the geometrical data storage unit 121 and detects elements that have lost continuity in the boundary plane between a moved region and a stationary region. That is, the variable combination unit 132 determines which adjacent elements on the opposite sides of the boundary plane have lost their shared edges as a result of the movement. When such discontinuous elements are found, the variable combination unit 132 selects their pertinent planes either as master planes or as slave planes. The variable combination unit 132 may perform the selection of master and slave planes on its own policies or according to the user's commands. Referring to, for example, the model of a motor 30 in FIG. 4, pertinent planes of its stator 31 may be selected as master planes and those of its rotor 32 may be selected as slave planes.

The variable combination unit 132 also defines variables representing unknowns assigned to each edge of model elements. The unknown at an edge takes a scalar value by which the edge's basis function is multiplied. In other words, this unknown indicates the magnitude of the vector potential at that edge. The variable combination unit 132 then makes such variables of slave-plane edges dependent on the variables of overlapping master-plane edges. That is, each slave-plane variable is replaced with a linear polynomial of master-plane variables. The variable combination unit 132 produces weight data that indicates the weights (i.e., real number coefficients) of variables in those linear polynomials and stores the produced weight data into the weight data storage unit 122.

The equation generation unit 133 reads out weight data from the weight data storage unit 122 and produces simultaneous equations of the variables that the above variable combination unit 132 has defined for each edge, based on the linear polynomials indicated by the weight data. In this process, the equation generation unit 133 does not express the unknowns of slave-plane edges as independent variables, but treats them as variables dependent upon unknowns of master planes, according to the linear polynomials given by the weight data. The equation generation unit 133 generates a coefficient matrix from a collection of coefficients of the simultaneous equations and sends it to the equation storage unit 123. Generally the coefficient matrix includes a large number of entries, but many of them have a value of zero (i.e., sparse matrix).

The solver unit 134 reads a coefficient matrix out of the equation storage unit 123 and solves the corresponding simultaneous equations by applying various operations to the coefficient matrix. There are known algorithms for this solution. The solver unit 134 calculates the unknown of each edge of elements, thus determining vector potentials of the edges. The unknowns of slave-plane edges are calculated not directly from the simultaneous equations, but from other linear equations containing pertinent master-plane unknowns and their weight data. These master-plane unknowns belong to edges of one or more master planes that overlap with the slave plane in question. The solver unit 134 compiles an analysis result from the calculated unknowns and the like and sends it to the analysis result storage unit 124. The solver unit 134 may visualize the analysis result and present it on the monitor 111. For example, a distribution of vector potential may be represented by arrows or color gradations.

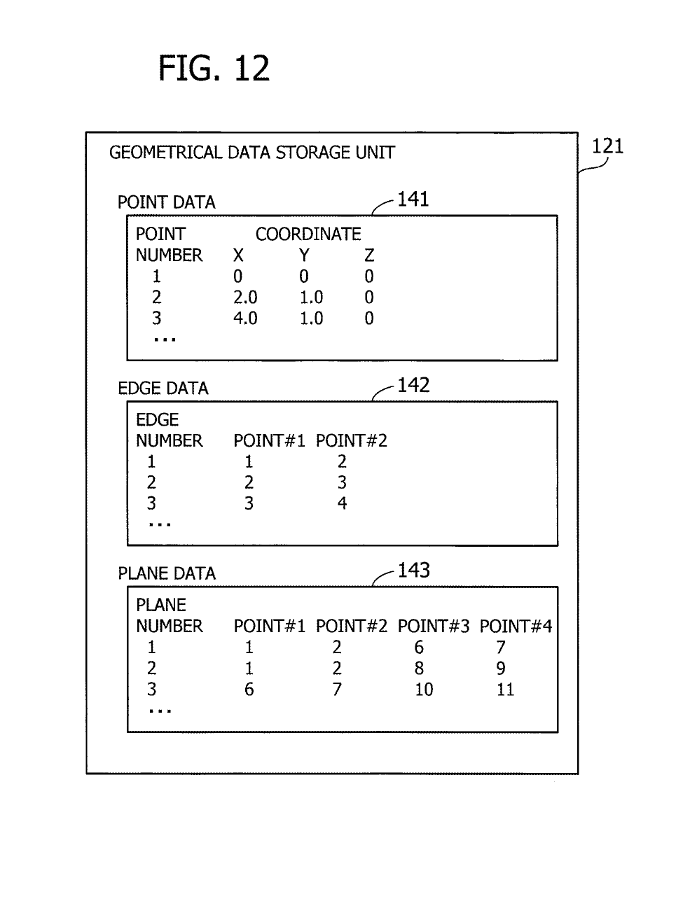

FIG. 12 illustrates an exemplary structure of geometrical data. What is stored in the illustrated geometrical data storage unit 121 includes point data 141, edge data 142, and plane data 143. The point data 141 gives a set of nodes. The edge data 142 gives a set of edges each defined between a pair of nodes. The plane data 143 gives a set of planes each defined by a plurality of nodes (e.g., three nodes for a tetrahedral element, four nodes for a hexahedral element).

More specifically, the point data 141 in FIG. 12 includes the following data fields: point number, X coordinate, Y coordinate, and Z coordinate. The point number field contains a natural number as an identifier indicating a specific node. The X, Y, and Z coordinate fields indicate the node's position in the model space. The edge data 142 is formed from the following data fields: edge number, point #1, and point #2. The edge number field contains a natural number as an identifier indicating a specific edge. The point #1 and point #2 fields contain two point numbers to specify the end node positions of a specific edge. The plane data 143 is formed from the following data fields: plane number, point #1, point #2, point #3, and point #4. The plane number field contains a natural number as an identifier indicating a specific plane. The point #1 to point #4 fields contain four point numbers to specify the corner node positions of a specific plane. The point #4 field may be empty for tetrahedral elements. Note that this plane data 143 may be modified to use edge numbers in place of point numbers for identifying a plane.

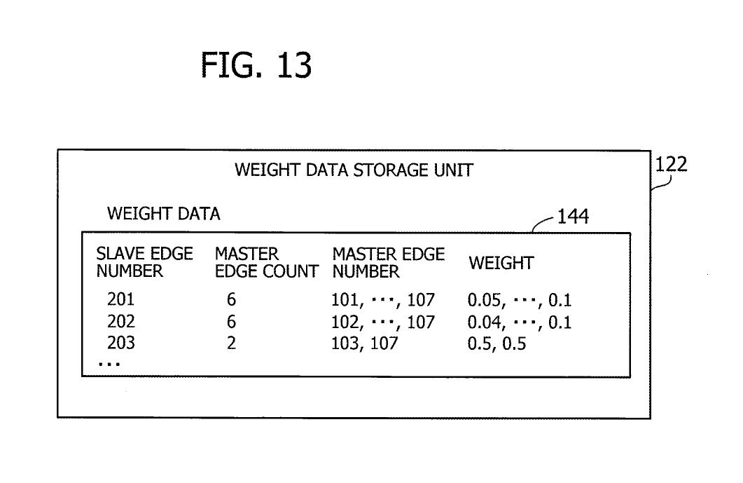

FIG. 13 illustrates an exemplary structure of weight data. The weight data storage unit 122 provides a storage space for weight data 144. This weight data 144 offers linear polynomials for calculating unknowns of slave-plane edges. Specifically, the illustrated weight data 144 is formed from the following data fields: slave edge number, master edge count, master edge number, and weight.

The slave edge number field contains an edge number that indicates a specific edge of a slave plane. The master edge count field gives the number of master-plane edges pertinent to the unknown of a slave-plane edge that the slave edge number field indicates. This field indicates how many variables of master planes appear in the linear polynomial. The master edge number field specifies a list of edges of pertinent master planes by using edge numbers, thus indicating which master-plane edges relate to the unknown of a slave-plane edge that the slave edge number field indicates. This field contains as many edge numbers as indicated in the master edge count field. The weight field gives a list of real numbers that serve as coefficients for the variables of pertinent master-plane edges relating to the unknown of a slave-plane edge that the slave edge number field indicates. The weight field contains as many real numbers as indicated by the master edge count field.

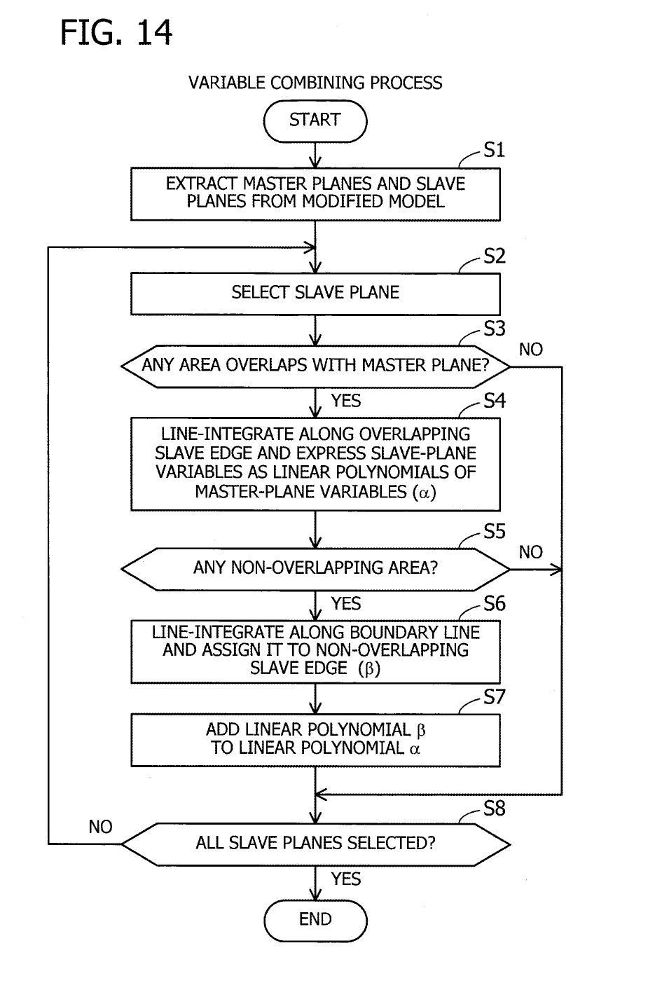

FIG. 14 is a flowchart illustrating an exemplary procedure for combining variables. In step S1, the element calculation unit 131 modifies the model by moving at least a movable component (e.g., rotor 32) of the modeled object (e.g., motor 30). The variable combination unit 132 then extracts elements located at the boundary between the moved component and stationary components. The variable combination unit 132 further extracts master planes from the elements on one side of the boundary plane and slave planes from the elements on the other side of the same. These master and slave planes belong to the boundary plane. The choice of which side is master may be determined by the variable combination unit 132 itself or may be selected by the user. Preferably, one component may contain either master planes or slave planes, but not both.

In step S2, the variable combination unit 132 selects one of the slave planes extracted at step S1.

In step S3, the variable combination unit 132 determines whether the selected slave plane contains any area that overlaps with one of the master planes. This test for an overlap of two planes is made by calculating the position of each plane on the basis of the foregoing point data 141 and plane data 143 stored in the geometrical data storage unit 121. The process advances to step S4 when the selected slave plane has an overlapping area. Otherwise, the process skips to step S8.

In step S4, the variable combination unit 132 identifies one or more master planes that overlap with the currently selected slave plane. The variable combination unit 132 calculates line integrals of vector potentials in these master planes along individual slave-plane edges that belong to the overlapping area. The edge positions of a slave plane are calculated from the point data 141 and edge data 142 in the geometrical data storage unit 121. The vector potentials in a master plane are expressed by using a basis function and a variable assigned to each edge of the master plane. The noted line integrals are therefore expressed in linear polynomials of the master-plane variables, and these linear polynomials correspond to the variables of edges of the slave plane when the presence of a non-overlapping area is disregarded.

In step S5, the variable combination unit 132 determines whether the selected slave plane has an area that does not overlap with any master plane. When the selected slave plane has such a non-overlapping area, the process advances to step S6. When the slave plane has no such area, the variable combination unit 132 updates weight data 144 in the weight data storage unit 122 to register the linear polynomials obtained in step S4. The process then proceeds to step S8.

In step S6, the variable combination unit 132 calculates a boundary line between the overlapping area and non-overlapping area in the selected slave plane. The variable combination unit 132 then calculates a line integral of master-plane vector potentials along the boundary line and determines, based on this line integral, a contribution from the boundary line to a non-overlapping part of the slave-plane edges. Here the contribution to each non-overlapping line segment is supposed to be proportional to a line integral of the basis function of that segment along the boundary line. The determined contribution is expressed in a linear polynomial of master-plane variables.

In step S7, the variable combination unit 132 adds the contribution term calculated in step S6 to the linear polynomial calculated in step S4 for each edge of the selected slave plane. The resulting linear polynomials correspond to the variables of slave-plane edges when the presence of a non-overlapping area is considered. The unknown of each edge of the selected slave plane is expressed by using variables of the master planes. The variable combination unit 132 thus registers the obtained linear polynomials as new entries of the weight data 144.

In step S8, the variable combination unit 132 determines whether all the slave planes extracted at step S1 have been selected and subjected to the above processing. If so, the variable combining process is terminated. If there is any pending slave plane, then the process returns to step S2 to continue.

According to the second embodiment described above, the proposed magnetic field simulator apparatus 100 executes an edge-based FEM analysis in which a slave plane may partly overlap with master planes. The magnetic field simulator apparatus 100 calculates a linear polynomial representing an unknown on the basis of vector potentials of master planes, for overlapping line segments of the slave-plane edges. For non-overlapping line segments of the slave-plane edges, the magnetic field simulator apparatus 100 calculates a linear polynomial representing a contribution from the boundary between the overlapping area and non-overlapping area of the slave plane. This method makes it possible to properly express the unknown of a whole edge of a slave plane by using variables defined in master planes.

Although the slave plane is discontinuous with master planes (i.e., does not share any edge with master planes), a flow of magnetic flux between their respective elements is properly expressed, and this feature leads to an improved accuracy of magnetic field analysis. The slave plane may even include a non-overlapping area that has no master planes to overlap with. The proposed method also serves well for such non-overlapping areas, thus providing the same advantages noted above. The proposed method is helpful in an edge-based FEM analysis for magnetic field of an object made up of multiple components whose relative positions may change (e.g., motors), since it eliminates the need for restructuring elements of the model each time they have new positions.

The proposed method calculates vector potentials in consideration of a contribution to a non-overlapping area of a slave plane from its boundary line with an overlapping area. The amount of this contribution depends on where the line segment of interest is located in the non-overlapping area with respect to the boundary line. Specifically, a larger contribution is given to a line segment running in parallel with the boundary line, whereas a smaller contribution is given to a line segment perpendicular to the boundary line. This reduces the effect of contributions from one slave plane to its neighboring slave planes and thus improves the accuracy of magnetic field analysis. It also simplifies edge-based FEM computation, thus reducing the workload of magnetic field analysis.

The information processing process discussed in the first embodiment may actually be implemented as a program for a magnetic field simulator apparatus 10. Similarly, the information processing process discussed above in the second embodiment may be implemented as a program for a magnetic field simulator apparatus 100. These programs may be stored in a non-transitory computer-readable medium (e.g., storage medium 113 in FIG. 2). For example, the suitable storage media for this purpose include (but are not limited to) magnetic disks, optical discs, magneto-optical discs, and semiconductor memory devices. More specifically, magnetic disk media include FD and HDD. Optical disc media include CD, CD-Recordable (CD-R), CD-Rewritable (CD-RW), DVD, DVD recordable (DVD-R), and DVD rewritable (DVD-RW). A program may be distributed in the form of portable storage media. The program encoded in a portable storage medium may be executed after being copied to some other storage medium (e.g., HDD 103).

Two embodiments have been discussed above. According to one aspect of the embodiments, the proposed techniques enable a magnetic field simulation of an object even if the object includes components whose relative positions may vary.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a program that causes a computer to perform a procedure comprising:
calculating, based on position data indicating a position of a first plane in a model and first magnetic field data for the first plane, second magnetic field data for an overlapping area of a second plane in the model, the first and second planes respectively belonging to first and second elements of the model, the overlapping area being a part of the second plane that overlaps with the first plane, the second plane having a non-overlapping area that is outside the first plane; and
calculating third magnetic field data for the non-overlapping area of the second plane, based on the second magnetic field data and a relative position of the non-overlapping area with respect to the overlapping area.

2. The non-transitory computer-readable storage medium according to claim 1, wherein:
the second magnetic field data includes a first vector record corresponding to a boundary between the overlapping area and the non-overlapping area;
the third magnetic field data includes a plurality of second vector records corresponding a plurality of edges of the non-overlapping area; and
the calculating third magnetic field data includes distributing a value indicated by the first vector record to the edges of the non-overlapping area, depending on relative positions of the individual edges with respect to the boundary.

3. The non-transitory computer-readable storage medium according to claim 2, wherein:
the boundary is indicated by a first direction vector;
the plurality of edges of the non-overlapping area are respectively indicated by a plurality of second direction vectors; and
the distributing distributes different fractions of the value indicated by the first vector record to the edges of the non-overlapping area, depending on magnitude of an inner product of the first direction vector and each of the second direction vectors.

4. The non-transitory computer-readable storage medium according to claim 2, wherein:
the second magnetic field data further includes a plurality of third vector records each corresponding to edges of the overlapping area; and
the procedure further comprises combining the third vector records in the second magnetic field data with the second vector records in the third magnetic field data.

5. A magnetic field simulator apparatus comprising:
a memory that stores position data indicating a position of a first plane in a model and a first magnetic field data for the first plane, the model including a first element having the first plane and a second element having a second plane, the second plane including an overlapping area that overlaps with the first plane and a non-overlapping area that is outside the first plane; and
a processor configured to perform a procedure including:
calculating second magnetic field data for the overlapping area of the second plane, based on the position data and the first magnetic field data, and
calculating third magnetic field data for the non-overlapping area of the second plane, based on the second magnetic field data and a relative position of the non-overlapping area with respect to the overlapping area.

6. A magnetic field simulation method comprising:
calculating, by a processor, based on position data indicating a position of a first plane in a model and first magnetic field data for the first plane, second magnetic field data for an overlapping area of a second plane in the model, the first and second planes respectively belonging to first and second elements of the model, the overlapping area being a part of the second plane that overlaps with the first plane, the second plane having a non-overlapping area that is outside the first plane; and
calculating, by the processor, third magnetic field data for the non-overlapping area of the second plane, based on the second magnetic field data and a relative position of the non-overlapping area with respect to the overlapping area.
